(19) United States
(12) Patent Application Publication
(10) Pub. No.: US 2026/0104996 A1
(43) Pub. Date: Apr. 16, 2026

(54) CONTROLLERS, METHODS OF OPERATING CONTROLLERS, MEMORY SYSTEMS AND ELECTRONIC DEVICES

(71) Applicant: YANGTZE MEMORY TECHNOLOGIES CO., LTD., Wuhan (CN)

(72) Inventor: Teng ZHOU, Wuhan (CN)

(21) Appl. No.: 19/091,526

(22) Filed: Mar. 26, 2025

(30) Foreign Application Priority Data
Oct. 10, 2024 (CN) 202411412315.7

(51) Int. Cl. G06F 12/02

(52) U.S. Cl. CPC G06F 12/0246

(57) ABSTRACT

The present disclosure provides a controller, a method of operating the controller, a memory system and an electronic device. The controller includes a buffer and a processor. The processor is configured to send a plurality of first read instructions to a memory. Each of the first read instructions comprises an address, a reference read voltage, and a voltage offset of a first storage area of the memory. The voltage offsets in at least two of the plurality of first read instructions are different. The processor is further configured to obtain a plurality of sets of first data, and obtain a log likelihood ratio table according to the plurality of sets of first data.

### CROSS-REFERENCE TO RELATED APPLICATIONS

The present application claims priority to Chinese Patent Application No. 202411412315.7, which was filed Oct. 10, 2024, and is hereby incorporated herein by reference in its entirety.

### TECHNICAL FIELD

The present disclosure relates to the field of semiconductor technology, and in particular to controllers, methods of operating the controller, memory systems, and electronic devices.

### BACKGROUND

In order to enhance the reliability of reading data from a memory (such as NAND), the read data can be decoded by low density parity check code (LDPC) to obtain the target data. However, the LDPC decoding performance may be reduced due to changes in the memory operating conditions.

### SUMMARY

Examples of the present disclosure provide a controller, a method of operating a controller, a memory system, and an electronic device to improve LDPC decoding performance.

To achieve the above objectives, the examples of the present disclosure adopt the following technical solutions:

In a first aspect, an example of the present disclosure provides a controller, including: a buffer; and a processor coupled to the buffer and configured to: send a plurality of first read instructions to a memory, where each of the first read instructions includes an address, a reference read voltage, and a voltage offset of a first storage area of the memory, and where the voltage offsets in at least two of the plurality of first read instructions are different; obtain a plurality of sets of first data; and obtain a log likelihood ratio table according to the plurality of sets of first data.

In some examples, the processor is further configured to: send a plurality of second read instructions to the memory, where each of the second read instructions includes an address, a reference read voltage and a voltage offset of a second storage area of the memory, and where the voltage offsets in at least two of the plurality of second read instructions are different; obtain a plurality of sets of second data; and obtain decoded data of the second storage area according to the plurality of sets of second data and the log likelihood ratio table.

In some examples, the processor is configured to: determine a characteristic value of the first storage area according to the plurality of sets of first data; and obtain the log likelihood ratio table according to the plurality of sets of first data and the characteristic value of the first storage area.

In some examples, the processor is further configured to: send a plurality of second read instructions to the memory to obtain a plurality of sets of second data, where each of the second read instructions includes an address, a reference read voltage and a voltage offset of a second storage area of the memory, and where the voltage offsets in at least two of the plurality of second read instructions are different; determine a characteristic value of the second storage area according to the plurality of sets of second data; and obtain decoded data of the second storage area according to the characteristic value of the second storage area and the log likelihood ratio table.

In some examples, the processor is further configured to: obtain the log likelihood ratio table according to target data and the plurality of sets of first data, where the target data is obtained by the processor decoding data read from the first storage area.

In some examples, the processor is configured to: obtain a plurality of voltage intervals according to the reference read voltage and the voltage offset; and obtain the log likelihood ratio table according to the target data and the plurality of voltage intervals.

In some examples, the processor is configured to: obtain a log likelihood ratio for each of the voltage intervals according to the target data and the plurality of voltage intervals; and obtain the log likelihood ratio table according to the log likelihood ratio for each of the voltage intervals.

In some examples, data stored in the first storage area has not been subjected to redundant array of independent disks (RAID) reconstruction.

In some examples, each of the first read instructions includes one reference read voltage and one voltage offset, and where the reference read voltage is offset based on the voltage offset.

In some examples, each of the first read instructions includes a first reference read voltage, a second reference read voltage, a first voltage offset and a second voltage offset, and where the first reference read voltage is offset based on the first voltage offset, and the second reference read voltage is offset based on the second voltage offset.

In a second aspect, an example of the present disclosure provides a method of operating a controller, including: sending a plurality of first read instructions to a memory, where each of the first read instructions includes an address, a reference read voltage, and a voltage offset of a first storage area of the memory, and where the voltage offsets in at least two of the plurality of first read instructions are different; obtaining a plurality of sets of first data; and obtaining a log likelihood ratio table according to the plurality of sets of first data.

In some examples, the method further includes: sending a plurality of second read instructions to the memory, where each of the second read instructions includes an address, a reference read voltage and a voltage offset of a second storage area of the memory, and where the voltage offsets in at least two of the plurality of second read instructions are different; obtaining a plurality of sets of second data; and obtaining decoded data of the second storage area according to the plurality of sets of second data and the log likelihood ratio table.

In some examples, the method further includes: determining a characteristic value of the first storage area according to the plurality of sets of first data; and obtaining the log likelihood ratio table according to the plurality of sets of first data and the characteristic value of the first storage area.

In some examples, the method further includes: sending a plurality of second read instructions to the memory to obtain a plurality of sets of second data, where each of the second read instructions includes an address, a reference read voltage and a voltage offset of a second storage area of the memory, and where the voltage offsets in at least two of the plurality of second read instructions are different; determining a characteristic value of the second storage area according to the plurality of sets of second data; and obtaining decoded data of the second storage area according to the characteristic value of the second storage area and the log likelihood ratio table.

In some examples, obtaining a log likelihood ratio table according to the plurality of sets of first data includes: obtaining the log likelihood ratio table according to target data and the plurality of sets of first data, where the target data is obtained by a controller decoding data read from the first storage area.

In some examples, obtaining the log likelihood ratio table according to target data and the plurality of sets of first data includes: obtaining a plurality of voltage intervals according to the reference read voltage and the voltage offset; and obtaining the log likelihood ratio table according to the target data and the plurality of voltage intervals.

In some examples, obtaining the log likelihood ratio table according to the target data and the plurality of voltage intervals includes: obtaining a log likelihood ratio for each of the voltage intervals according to the target data and the plurality of voltage intervals; and obtaining the log likelihood ratio table according to the log likelihood ratio for each of the voltage intervals.

In some examples, data stored in the first storage area has not been subjected to redundant array of independent disks (RAID) reconstruction.

In some examples, each of the first read instructions includes one reference read voltage and one voltage offset, and where the reference read voltage is offset based on the voltage offset.

In some examples, each of the first read instructions includes a first reference read voltage, a second reference read voltage, a first voltage offset and a second voltage offset, and where the first reference read voltage is offset based on the first voltage offset, and the second reference read voltage is offset based on the second voltage offset.

In a third aspect, an example of the present disclosure provides a memory system, including: a memory; and a controller coupled to the memory and including: a buffer; and a processor coupled to the buffer and configured to: send a plurality of first read instructions to a memory, where each of the first read instructions includes an address, a reference read voltage, and a voltage offset of a first storage area of the memory, and where the voltage offsets in at least two of the plurality of first read instructions are different; obtain a plurality of sets of first data; and obtain a log likelihood ratio table according to the plurality of sets of first data.

In some examples, the controller is further configured to: send a plurality of second read instructions to the memory, where each of the second read instructions includes an address, a reference read voltage and a voltage offset of a second storage area of the memory, and where the voltage offsets in at least two of the plurality of second read instructions are different; obtain a plurality of sets of second data; and obtain decoded data of the second storage area according to the plurality of sets of second data and the log likelihood ratio table.

In some examples, the controller is configured to: determine a characteristic value of the first storage area according to the plurality of sets of first data; and obtain the log likelihood ratio table according to the plurality of sets of first data and the characteristic value of the first storage area.

In some examples, the controller is further configured to: send a plurality of second read instructions to the memory to obtain a plurality of sets of second data, where each of the second read instructions includes an address, a reference read voltage and a voltage offset of a second storage area of the memory, and where the voltage offsets in at least two of the plurality of second read instructions are different; determine a characteristic value of the second storage area according to the plurality of sets of second data; and obtain decoded data of the second storage area according to the characteristic value of the second storage area and the log likelihood ratio table.

In some examples, the controller is further configured to: obtain the log likelihood ratio table according to target data and the plurality of sets of first data, where the target data is obtained by the controller decoding data read from the first storage area.

In some examples, the controller is configured to: obtain a plurality of voltage intervals according to the reference read voltage and the voltage offset; and obtain the log likelihood ratio table according to the target data and the plurality of voltage intervals.

In some examples, the controller is configured to: obtain a log likelihood ratio for each of the voltage intervals according to the target data and the plurality of voltage intervals; and obtain the log likelihood ratio table according to the log likelihood ratio for each of the voltage intervals.

In some examples, data stored in the first storage area has not been subjected to redundant array of independent disks (RAID) reconstruction.

In some examples, each of the first read instructions includes one reference read voltage and one voltage offset, and where the reference read voltage is offset based on the voltage offset.

In some examples, each of the first read instructions includes a first reference read voltage, a second reference read voltage, a first voltage offset and a second voltage offset, and where the first reference read voltage is offset based on the first voltage offset, and the second reference read voltage is offset based on the second voltage offset.

In a fourth aspect, an example of the present disclosure provides a method of operating a memory system, including: sending, by a controller, a plurality of first read instructions to a memory, where each of the first read instructions includes an address, a reference read voltage, and a voltage offset of a first storage area of the memory, and where the voltage offsets in at least two of the plurality of first read instructions are different; obtaining a plurality of sets of first data; and obtaining a log likelihood ratio table according to the plurality of sets of first data.

In some examples, the method further includes: sending a plurality of second read instructions to the memory, where each of the second read instructions includes an address, a reference read voltage and a voltage offset of a second storage area of the memory, and where the voltage offsets in at least two of the plurality of second read instructions are different; obtaining a plurality of sets of second data; and obtaining decoded data of the second storage area according to the plurality of sets of second data and the log likelihood ratio table.

In some examples, the method of the memory system further includes: determining a characteristic value of the first storage area according to the plurality of sets of first data; and obtaining the log likelihood ratio table according to the plurality of sets of first data and the characteristic value of the first storage area.

In some examples, the operation method further includes: sending a plurality of second read instructions to the memory to obtain a plurality of sets of second data, where each of the second read instructions includes an address, a reference read voltage and a voltage offset of a second storage area of the memory, and where the voltage offsets in at least two of the plurality of second read instructions are different; determining a characteristic value of the second storage area according to the plurality of sets of second data; and obtaining decoded data of the second storage area according to the characteristic value of the second storage area and the log likelihood ratio table.

In some examples, obtaining a log likelihood ratio table according to the plurality of sets of first data includes: obtaining the log likelihood ratio table according to target data and the plurality of sets of first data, where the target data is obtained by a controller decoding data read from the first storage area.

In some examples, obtaining the log likelihood ratio table according to target data and the plurality of sets of first data includes: obtaining a plurality of voltage intervals according to the reference read voltage and the voltage offset; and obtaining the log likelihood ratio table according to the target data and the plurality of voltage intervals.

In some examples, obtaining the log likelihood ratio table according to the target data and the plurality of voltage intervals includes: obtaining a log likelihood ratio for each of the voltage intervals according to the target data and the plurality of voltage intervals; and obtaining the log likelihood ratio table according to the log likelihood ratio for each of the voltage intervals.

In some examples, data stored in the first storage area has not been subjected to redundant array of independent disks RAID reconstruction.

In some examples, each of the first read instructions includes one reference read voltage and one voltage offset, and where the reference read voltage is offset based on the voltage offset.

In some examples, each of the first read instructions includes a first reference read voltage, a second reference read voltage, a first voltage offset and a second voltage offset, and where the first reference read voltage is offset based on the first voltage offset, and the second reference read voltage is offset based on the second voltage offset.

In a fifth aspect, an example of the present disclosure provides an electronic device, including: a host; and the memory system of any of the third aspect coupled to the host.

In a sixth aspect, an example of the present disclosure provides a computer storage medium including instructions that, when run on a processor, cause the processor to perform the method of any of the second aspect, or perform the method of any of the fourth aspect.

### BRIEF DESCRIPTION OF THE DRAWINGS

In order to more clearly illustrate the technical solutions in the present disclosure, the following briefly introduces the drawings required to be used in some examples of the present disclosure. Obviously, the drawings described below are only drawings of some examples of the present disclosure. For ordinary people skilled in the art, other drawings can also be obtained based on these drawings. In addition, the drawings described below can be regarded as schematic diagrams, and are not limitations on the actual size of the product, the actual process of the method, the actual timing of the signal and the like involved in the examples of the present disclosure.

FIG. 1 is a structural schematic diagram 1 of an electronic device according to some examples;

FIG. 2 is a structural schematic diagram 2 of an electronic device according to some examples;

FIG. 3 is a structural schematic diagram of a memory card according to some examples;

FIG. 4 is a structural schematic diagram of a solid state drive according to some examples;

FIG. 5 is a structural schematic diagram 1 of a memory according to some examples;

FIG. 6 is a structural schematic diagram 2 of a memory according to some examples;

FIG. 7 is a schematic diagram 1 of a threshold voltage distribution of memory cells according to some examples;

FIG. 8 is a schematic diagram 2 of a threshold voltage distribution of memory cells according to some examples;

FIG. 9 is a schematic diagram 3 of a threshold voltage distribution of memory cells according to some examples;

FIG. 10 is a schematic flow diagram of error checking and correction for read data according to some examples;

FIG. 11 is a schematic diagram of two adjacent distribution states in a threshold voltage distribution of memory cells according to some examples;

FIG. 12 is a schematic diagram of credibility for different voltage intervals according to some examples;

FIG. 13 is a schematic diagram 1 of a data reading method according to some examples;

FIG. 14 is a schematic diagram 2 of a data reading method according to some examples;

FIG. 15 is a schematic diagram 3 of a data reading method according to some examples;

FIG. 16 is a schematic diagram 4 of a data reading method according to some examples;

FIG. 17 is a schematic flow diagram of a method of optimizing an LLR table according to some examples;

FIG. 18 is a schematic diagram 5 of a data reading method according to some examples;

FIG. 19 is a schematic diagram 6 of a data reading method according to some examples;

FIG. 20 is a schematic diagram 7 of a data reading method according to some examples;

FIG. 21 is a schematic diagram 4 of a threshold voltage distribution of memory cells according to some examples;

FIG. 22 is a schematic diagram 5 of a threshold voltage distribution of memory cells according to some examples;

FIG. 23 is a schematic diagram 6 of a threshold voltage distribution of memory cells according to some examples;

FIG. 24 is a schematic flow diagram 1 of a method of operating a controller according to some examples;

FIG. 25 is a schematic flow diagram 2 of a method of operating a controller according to some examples;

FIG. 26 is a schematic flow diagram 1 of a method of operating a memory system according to some examples;

FIG. 27 is a schematic flow diagram 2 of a method of operating a memory system according to some examples.

### DETAILED DESCRIPTION

The technical solutions in some examples of the present disclosure will be described clearly and completely in the following in conjunction with the accompanying drawings, and it is clear that the described examples are only a part of the examples of the present disclosure, and not all of the examples. Based on the examples provided in the present disclosure, all other examples obtained by ordinary skills in the art fall within the scope of protection of the present disclosure.

In the description of the present disclosure, the terms “center”, “up”, “down”, “front”, “back”, “left”, “right”, “vertical”, “horizontal”, “top”, “bottom”, “inside”, “outside” and the like indicate orientations or positional relationships based on those shown in the accompanying drawings, and are intended only to facilitate description of the present disclosure and to simplify the description, and are not intended to indicate or imply that the device or element referred to must have a particular orientation, be constructed and operated in a particular orientation, and therefore are not to be construed as limitations on the present disclosure.

Unless the context requires otherwise, throughout the specification and claims, the term “including” is construed to be open, inclusive, e.g., “including, but not limited to”. In the description of the specification, the terms “one example”, “some examples”, “examples”, or “in some examples” and the like are intended to indicate that particular features, structures, materials, or characteristics associated with the example is included in at least one example of the present disclosure. The schematic meaning of the above terms does not refer to the same example. Moreover, the particular features, structures, materials, or characteristics described may be included in any one or more examples in any appropriate manner.

Hereinafter, the terms “first”, “second” are used for descriptive purposes only and are not to be understood as indicating or implying relative importance or implicitly specifying the number of technical features indicated. Thus, a feature defined with the terms “first”, “second” may expressly or impliedly include one or more such features. In the description of examples of the present disclosure, “a plurality of” means two or more unless otherwise indicated.

In describing some examples, the expressions “coupled” and “connected” and derivatives thereof may be used. For example, the term “connected” may be used in describing some examples to indicate that two or more components are in direct physical or electrical contact with each other. As another example, the term “coupled” may be used in describing some examples to indicate that two or more components are in direct physical or electrical contact with each other. However, the term “coupled” may also indicate that two or more components are not in direct contact with each other, but still work or interact with each other. The examples disclosed herein are not limited to the context herein.

“At least one of A, B, and C” has the same meaning as “at least one of A, B, or C” and both include the following combinations of A, B, and C: A only, B only, C only, a combination of A and B, a combination of A and C, a combination of B and C, and a combination of A, B, and C.

“At least one of A or B” includes the following three combinations: A only, B only, and a combination of A and B.

The use of “adapted to” or “configured to” herein implies open and inclusive language that does not exclude devices that are adapted or configured to perform additional tasks or operations.

Additionally, the use of “based on” implies open and inclusive language, as a process, operation, calculation, or other action “based on” one or more of stated conditions or values may, in practice, be based on additional conditions or values beyond those stated.

The present disclosure is not limited to three-dimensional (3D) NAND memory devices, although 3D NAND memory devices may be used in some examples to illustrate the inventive concepts. For example, the technology disclosed herein can be applied to planar NAND memory devices and NOR memory devices, etc.

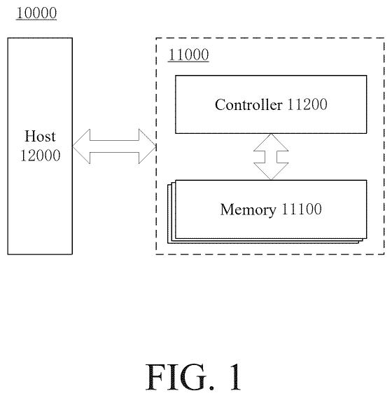

FIG. 1 shows a structural diagram of an electronic device 10000 having a storage device according to some aspects. The electronic device 10000 may include a mobile phone (e.g., a cell phone), a desktop computer, a tablet computer, a laptop computer, a server, an on-board device, a game console, a printer, a positioning device, a wearable device (e.g., a smart watch, a smart bracelet, smart glasses, etc.), a smart sensor, a mobile power supply, a virtual reality (VR) device, an augmented reality (AR) device, or any other suitable electronic device having a storage device therein. As shown in FIG. 1, the electronic device 10000 includes a memory system 11000 and a host 12000. The memory system 11000 includes one or more memories 11100 and a controller 11200 coupled to the memories 11100. The host 12000 may include a processor of an electronic device. In some examples, the processor may include a chip, such as a field programmable gate array (FPGA), an application specific integrated circuit (ASIC), a system on chip (SoC), a central processor unit (CPU), a network processor (NP), a digital signal processor (DSP), a microcontroller unit (MCU), a programmable logic device (PLD), an application processor (AP) or other integrated chips.

According to some examples, the controller 11200 is coupled to the memory 11100 and the host 12000, and is configured to control the memory 11100. The controller 11200 can manage data stored in the memory 11100 and communicate with the host 12000. In some examples, the controller 11200 is designed to operate in a low duty cycle environment, such as a secure digital (SD) card, a compact flash card (CF) card, a universal serial bus (USB) flash drive, or other media used in electronic devices such as personal computers, digital cameras, mobile phones, etc. In some examples, the controller 11200 is designed to operate in a high duty cycle environment, such as a solid state drive (SSD) or an embedded multimedia card (eMMC), which is used as a data storage device for mobile electronic devices such as smart phones, tablets, personal computers, etc. and an enterprise storage array.

The controller 11200 may be configured to manage data stored in the memory 11100 and communicate with an external device (e.g., the host 12000). The controller 11200 is configured to control the operation of the memory 11100, such as read, erase, and program operations. In some examples, the controller 11200 may also be configured to manage various functions related to data stored or to be stored in the memory 11100, including but not limited to bad block management, garbage collection, logical to physical address conversion, wear leveling, redundant array of independent disks (RAID), etc.

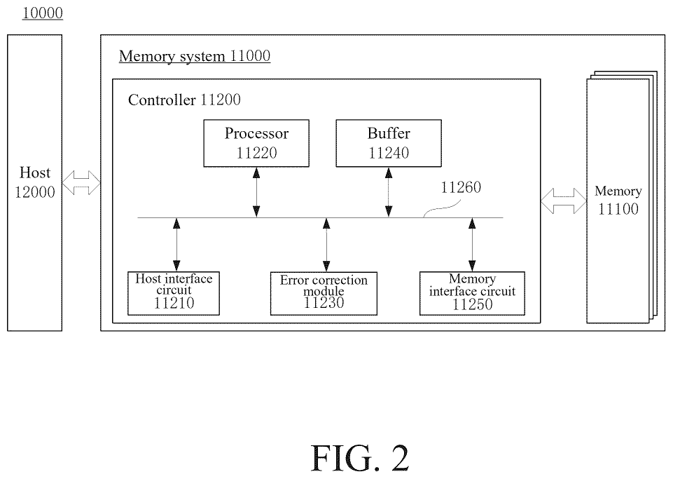

In some examples, the controller is further configured to handle error correction codes (ECC) related to data read from or written to the memory 11100. In the electronic device 10000 shown in FIG. 2, the controller 11200 includes at least a buffer 11240 and a processor 11220, and may also include a host interface circuit 11210, an error correction module 11230, a memory interface circuit 11250, and a connection bus 11260. In an example, the electronic device 10000 includes a complex device that integrates the memory system 11000 and the host 12000, where the memory system 11000 is responsible for the storage and retrieval of data, and the controller 11200 is configured to coordinate and manage these operations. The modules inside the controller 11200 enable high-speed and reliable data transmission and command communication through the connection bus 11260. The host interface circuit 11210, as a bridge to the external host 12000, is connected to the processor 11220 via the connection bus 11260, is responsible for receiving and sending data, commands and status information, and can adopt USB, SATA and PCIE interfacing methods and the like. The processor 11220 is the brain of the controller 11200, parsing commands from the host 12000 and coordinating other modules to perform corresponding operations.

During a data writing process, the processor 11220 controls the error correction module 11230 to encode original data. The data is encoded by adding ECC check codes, and then the encoded data is sent to the buffer 11240 for temporary storage through the connection bus 11260. The buffer 11240 serves as a temporary storage area to ensure the security and stability of the data before written into the memory 11100.

When data needs to be read, the processor 11220 sends a read command and an address to the memory 11100 through the memory interface circuit 11250. After the memory 11100 reads the data at the specified address, it returns the data to the controller 11200 through the memory interface circuit 11250. The data first enters into the buffer 11240, and then decoding and error detection is performed by the error correction module 11230 on the data. If there is no error in the data, the error correction module 11230 passes the data to the processor 11220 through the connection bus 11260; if an error is detected, the error correction module 11230 will notify the processor 11220, and the processor 11220 will decide the error check and correction method, such as performing a read retry, performing soft decoding in low density parity check code (LDPC), performing internal RAID, or reporting the error to the host 12000.

Throughout the process, the processor 11220 is also responsible for error handling and status reporting. If the error correction module 11230 detects an error, the processor 11220 will take appropriate measures according to the error type, such as perform a read retry, report the error to the host 12000, or execute other error handling processes. At the same time, the controller 11200 may also report the status of the memory 11100, error count and other information to the host 12000 through the host interface circuit 11210, so that the host 12000 can timely know the operating status of the memory system 11000. The memory system 11000 in the electronic device 10000 realizes efficient and stable storage and retrieval of data through the coordinated work of various modules inside the controller 11200. The existence of the connection bus 11260 ensures high-speed data transmission and command communication among the modules, so that the entire system can operate stably and efficiently.

The controller 11200 may also perform any other appropriate functions, such as formatting the memory 11100. The controller 11200 may communicate with an external device (e.g., the host 12000) according to a specific communication protocol. For example, the controller 11200 may communicate with an external device through at least one of various interface protocols, such as a USB protocol, a multimedia card (MMC) protocol, a peripheral component interconnect (PCI) protocol, an express PCI (PCI-E) protocol, an advanced technology attachment (ATA) protocol, a serial ATA protocol, a parallel ATA protocol, a small computer system interface (SCSI) protocol, an enhanced small device interface (ESDI) protocol, an integrated drive electronics (IDE) protocol, a Firewire protocol, etc.

Of course, the controller 11200 may also perform any other suitable functions, such as formatting the memory 11100. For example, the controller 11200 may communicate with an external device (e.g., a host) via at least one of various interface protocols.

It should be noted that the interface protocol includes at least one of the USB protocol, the MMC protocol, the peripheral component interconnect (PCI) protocol, the express PCI (PCI-E) protocol, the advanced technology attachment (ATA) protocol, the serial ATA protocol, the parallel ATA protocol, the small computer system interface (SCSI) protocol, the enhanced small device interface (ESDI) protocol, the integrated drive electronics (IDE) protocol, and the Firewire protocol.

The controller 11200 and one or more memories 11100 can be integrated into various types of memory systems 11000, for example, included in the same package, such as an embedded multimedia card (eMMC), a universal flash storage (UFS) package, an embedded multi chip package (eMCP) or a UFS-based multichip package (uMCP). Among them: eMMC employs unified MMC standard interfaces, and packages the high-density NAND and the MMC controller in a ball grid array (BGA) package chip; and UFS is an advanced version of eMMC, which also includes an array storage module composed of a plurality of flash memory chips and controllers. UFS makes up for the defect that eMMC only supports half-duplex operation (reading and writing must be performed separately), and can enable full-duplex operation, so the performance is doubled. eMCP is a package that carries a volatile memory such as static random access memory (SRAM) or dynamic random access memory (DRAM) on the eMMC.

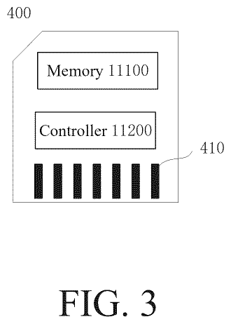

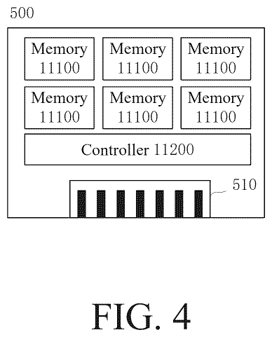

In an example, DRAM may include a low power double data rate SRAM (LPDDR). uMCP is packaged on UFS with a volatile memory (such as SRAM or DRAM), and has high performance and large capacity. In an example, DRAM may include LPDDR. For example, the memory system 11000 may be implemented and packaged into different types of end electronic devices. In an example as shown in FIG. 3, the controller 11200 and a single memory 11100 may be integrated into a memory card 400. The memory card 400 may include a PC card (PCMCIA, Personal Computer Memory Card International Association), a CF card, a Smart Media (SM) card, a memory stick, a multimedia card (MMC, RS-MMC, MMCmicro), a SD card (SD, miniSD, microSD, SDHC), UFS, etc. The memory card 400 may further include a memory card connector 410 that couples the memory card 400 with a host (e.g., the host 12000 in FIG. 1). In another example as shown in FIG. 4, the controller 11200 and a plurality of memories 11100 may be integrated into the SSD 500. The SSD 500 may further include an SSD connector 510 that couples the SSD 500 with a host (e.g., the host 12000 in FIG. 1 or FIG. 2). In some examples, at least one of the storage capacity or operating speed of the SSD 500 is higher than that of the memory card 400.

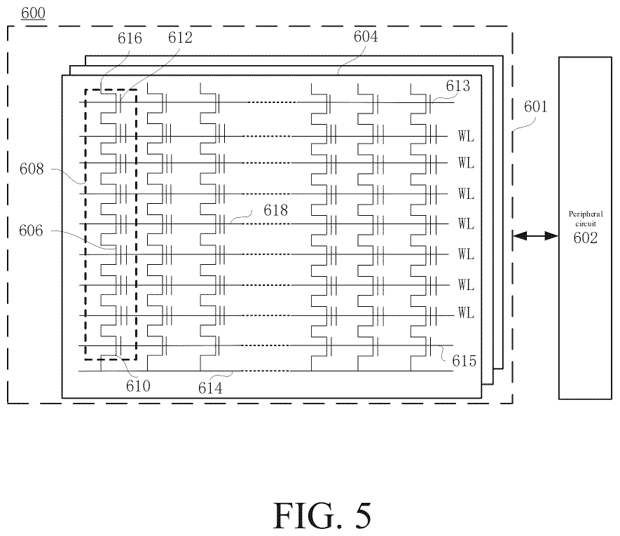

FIG. 5 shows a schematic circuit diagram of an example memory 600 including a peripheral circuit 602 according to some aspects of the present disclosure. The memory 600 may be an example of the memory 11100 in FIG. 1. The memory 600 may include a memory cell array 601 and a peripheral circuit 602 coupled to the memory cell array 601. The memory cell array 601 may include a NAND flash memory cell array, where the memory cells 606 are provided in the form of an array of NAND memory strings 608 each extending vertically above a substrate (not shown). In some examples, each NAND memory string 608 includes a plurality of memory cells 606 coupled in series and stacked vertically. Each memory cell 606 is capable of holding a continuous analog value, such as a voltage or charge, which depends on the number of electrons trapped in the region of the memory cell 606. Each memory cell 606 may be a floating gate type memory cell including a floating gate transistor, or may be a charge trapping type memory cell including a charge trapping transistor.

In some examples, each memory cell 606 is a single-level cell (SLC) having two possible memory states (levels) and thus capable of storing one bit of data. In some examples, each memory cell 606 may be configured to store N bits of data in one of 2^{N} memory states (levels), where N is a natural number greater than 0. The 2^{N} memory states include an erased state and 2^{N}−1 non-erased states. In some examples, each memory cell 606 is a single-level cell (SLC) having two possible memory states (levels) and thus capable of storing one bit of data. For example, a first memory state “0” may correspond to a first range of threshold voltages, and a second memory state “1” may correspond to a second range of threshold voltages. In some examples, each memory cell 606 is an xLC capable of storing more than one bit of data in four or more memory states (levels). For example, xLC can store two bits per cell (multi-level cell, MLC), three bits per cell (triple-level cell, TLC), or four bits per cell (quad-level cell, QLC). Each xLC can be programmed to assume a range of possible nominal storage values. In one example, the MLC can be programmed from an erased state to assume one of three possible programming levels by writing one of three possible nominal storage values (e.g., 01, 10, and 11) to the memory cell 606. A fourth nominal storage value can be used for the erased state (e.g., 00).

As shown in FIG. 5, each NAND memory string 608 may also include a source select gate (SSG) transistor 610 at its source terminal and a drain select gate (DSG) transistor 612 at its drain terminal. The SSG transistor 610 and the DSG transistor 612 may be configured to activate a selected NAND memory string 608 (column of the array) during read and program operations. In some examples, the sources of the NAND memory strings 608 in the same block 604 are coupled through the same source line (SL) 614 (e.g., a common SL). In other words, according to some examples, all NAND memory strings 608 in the same block 604 have an array common source (ACS). According to some examples, the drain of each NAND memory string 608 is coupled to a corresponding bit line 616, and data can be read or written from the corresponding bit line 616 via an output bus (not shown). In some examples, each NAND memory string 608 is configured to be selected or deselected by at least one of applying a select voltage or a deselect voltage to the gate of the corresponding DSG transistor 612 via one or more DSG lines 613 or applying a select voltage or a deselect voltage to the gate of the corresponding SSG transistor 610 via one or more SSG lines 615.

As shown in FIG. 5, NAND memory strings 608 can be organized into a plurality of blocks 604, each of which can have a common source line 614 coupled to an ACS, for example. In some examples, each block 604 is a basic data unit for an erase operation, e.g., all memory cells 606 on the same block 604 are erased at the same time. To erase the memory cells 606 in a selected block 604, the source lines 614 coupled to the selected block 604 and the unselected blocks 604 in the same plane as the selected block 604 can be biased with an erase voltage (Vers), such as a high positive bias voltage (e.g., 20V or higher). The memory cells 606 of adjacent NAND memory strings 608 can be coupled through a word line (WL) 618, which selects which row of memory cells 606 are affected by read and program operations.

The peripheral circuit 602 may be coupled to the memory cell array 601 via a bit line (BL) 616, a word line 618, a source line 614, an SSG line 615, and a DSG line 613. The peripheral circuit 602 may include any suitable analog, digital, and mixed signal circuits for facilitating operations of the memory cell array 601 by at least one of applying and sensing voltage signals or current signals to and from each target memory cell 606 via the bit line 616, the word line 618, the source line 614, the SSG line 615, and the DSG line 613. The peripheral circuit 602 may include various types of peripheral circuits formed using metal-oxide-semiconductor (MOS) technology.

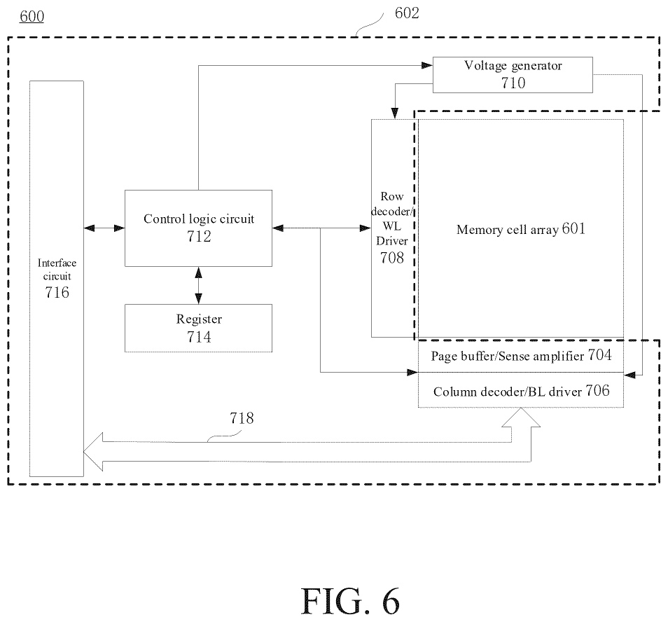

For example, FIG. 6 shows some example peripheral circuits, including a page buffer/sense amplifier 704, a column decoder/bit line driver 706, a row decoder/word line driver 708, a voltage generator 710, a control logic unit 712, a register 714, an interface circuit (I/F) 716, and a data bus 718. Additional peripheral circuits not shown in FIG. 6 may also be included.

The page buffer/sense amplifier 704 may be configured to read and program (write) data from and to the memory cell array 601 according to control signals from the control logic unit 712. In one example, the page buffer/sense amplifier 704 may perform a program verification operation to ensure that the data has been correctly programmed into the memory cells 606 coupled to the selected word line 618. In yet another example, the page buffer/sense amplifier 704 may also sense a low-power signal representing a data bit stored in the memory cell 606 from the bit line 616 in a read operation and amplify the small voltage swing to a recognizable logic level. As detailed below and consistent with the scope of the present disclosure, in a programming operation, the page buffer/sense amplifier 704 may include a storage module (e.g., a latch, a cache, a register, etc.) for temporarily storing a segment of N bits of data received from the data bus 718 and providing the segment of N bits of data to the corresponding target memory cell 606 through the corresponding bit line 616 in each programming pass of a multi-pass programming operation using a 2^{N}-2^{N} scheme.

The column decoder/bit line driver 706 may be configured to be controlled by the control logic unit 712, and select one or more NAND memory strings 608 by applying a bit line voltage generated by the voltage generator 710. The row decoder/word line driver 708 may be configured to be controlled by the control logic unit 712, and select/deselect the block 604 of the memory cell array 601, and select/deselect the word line 618 of the block 604. The row decoder/word line driver 708 may also be configured to drive the word line 618 using a word line voltage generated by the voltage generator 710. In some examples, the row decoder/word line driver 708 may also select/deselect and drive the SSG line 615 and the DSG line 613. The voltage generator 710 may be configured to be controlled by the control logic unit 712, and generate a word line voltage (e.g., a read voltage, a program voltage, a pass voltage, a local voltage, a verification voltage, etc.), a bit line voltage, and a source line voltage to be provided to the memory cell array 601.

The control logic unit 712 may be coupled to each peripheral circuit described above and configured to control the operations of each peripheral circuit. The register 714 may be coupled to the control logic unit 712 and include a status register, a command register, and an address register for storing status information, a command operation code (OP), and a command address for controlling the operations of each peripheral circuit. The interface circuit 716 may be coupled to the control logic unit 712 and act as a control buffer to buffer and forward control commands received from a host (e.g., the host 2000 in FIG. 1) to the control logic unit 712, and to buffer and forward status information received from the control logic unit 712 to the host. The interface circuit 716 may also be coupled to the column decoder/bit line driver 706 via the data bus 718 and act as a data input/output (I/O) interface and a data buffer to buffer and forward data to and from the memory cell array 601.

In actual applications, since the structural dimensions and doping concentrations of the plurality of memory cells 606 of the memory 600 cannot be completely the same, the threshold voltages of the plurality of memory cells 606 are not completely the same, so the threshold voltages for different data states (erased or programmed) are distributed within a certain range. The threshold voltage (Vth) is taken as the horizontal axis, and the number of memory cells (count) under different threshold voltages is taken as the vertical axis, so there is a threshold voltage distribution diagram (Vt distribution). Among them, for different types of memories, the larger the storage capacity of a single memory cell, the narrower the width of the threshold voltage distribution corresponding to a single data state.

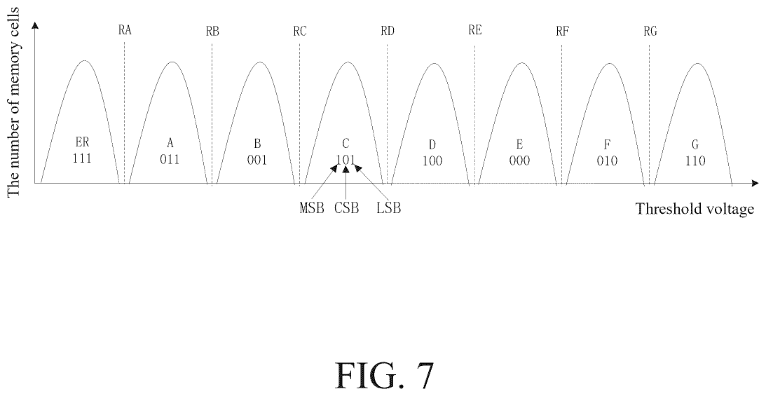

Taking each memory cell 606 configured to store three bits of data as an example, FIG. 7 shows a schematic diagram of a threshold voltage distribution of memory cells according to an example of the present disclosure. The horizontal axis represents the threshold voltages of the memory cells (expressed in Vth). The vertical axis represents the number of memory cells corresponding to different threshold voltages.

In FIG. 7, the memory cells may be memory cells corresponding to pages, code words (CW), word line memory cell strings, blocks, planes, dies, etc. in a 3D NAND memory device. The memory cells are TLCs and may be programmed (or erased) to be in one of eight states (memory states), e.g., an erased state ER, and programmed states A, B, C, D, E, F, and G. The memory cells programmed (or erased) to be in a specific state may have a threshold voltage distributed within a voltage interval. Accordingly, in FIG. 7, each state (the erased state ER, the programmed states A, B, C, D, E, F, and G) is shown as having a threshold voltage distribution.

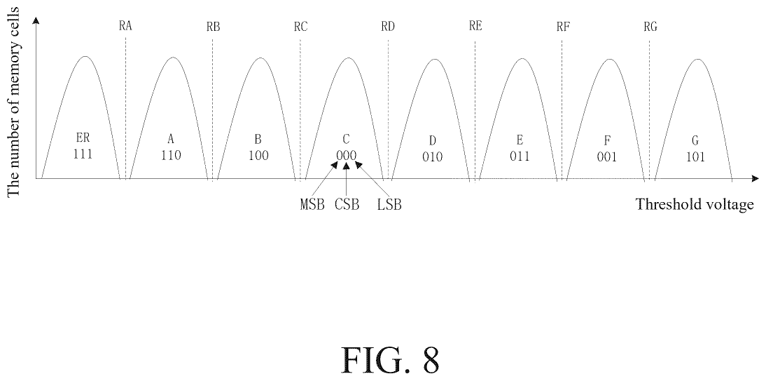

A TLC memory cell can represent three data bits, depending on which state the memory cell is in. In other words, three data bits can be encoded into one of the eight states. In different examples, the mapping between the states and the corresponding three data bits can vary. As shown in FIG. 7, the eight states from the erased state ER to the programmed states A, B, C, D, E, F, and G are mapped to 111, 011, 001, 101, 100, 000, 010, and 110, respectively. In FIG. 8, the eight states from the erased state ER to the programmed states A, B, C, D, E, F, and G are mapped to 111, 110, 100, 000, 010, 011, 001, and 101, respectively. The least significant bit (LSB) in these eight states can belong to the lower page (LP), the center significant bit (CSB) in these 8 states may belong to the middle page (MP), and the most significant bit (MSB) in these 8 states may belong to the upper page (UP).

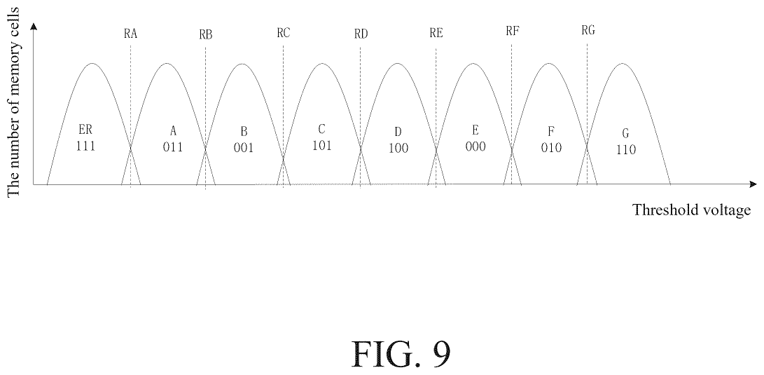

Taking the distribution shown in FIG. 7 as an example, in FIG. 7, seven default reference read voltages RA, RB, RC, RD, RE, RF and RG are located between threshold voltage distributions of corresponding memory cells. Ideally, each memory cell threshold voltage distribution can be contained within a range between two adjacent default reference read voltages. In other words, it is expected that the programmed or erased memory cell can maintain the expected state and thus maintain the three data bits represented. However, the memory cell threshold voltage distribution may offset or expand from one distribution to another due to reasons such as program/erase (P/E) cycles, retention years, write or read interference, temperature changes, coupling interference of adjacent word lines (WL), etc., as shown in FIG. 9. Since there is a certain overlap in the memory cell threshold voltage distribution, data read errors and reliability problems may occur.

In order to reduce data reading errors and improve the reliability of data reading, the examples of the present disclosure provide the following three error checking and correction methods for reading data.

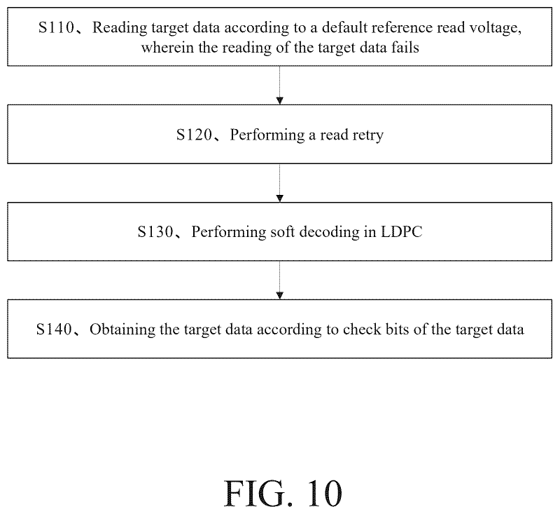

In a first example, error checking and correction is performed by executing a read retry scheme. In some examples, refer to FIG. 10, which shows a flow chart of the three read schemes. In operation S110, reading target data according to a default reference read voltage, and after the reading of the target data fails, operation S120 is executed to perform a read retry. In some examples, the operation S120 includes: traversing a read retry table, where the read retry table is predefined, and is configured to manage a plurality of offset values of the default reference read voltages of the memory. The read retry table can also be called as a pre-stored table. The default reference read voltage is offset left and right according to the plurality of offset values obtained by traversing the read retry table to repeatedly read the memory. In the process of the repeated reading, the number of error bits of the target data read each time is counted using a method of counting the number of error bits, to find the optimal reference read voltage for reading the target data.

In a second example, error checking and correction is performed by executing a soft decoding reading scheme in low density parity check code (LDPC). In some examples, as shown in FIG. 10, after the operation S120, operation S130 is performed to perform soft decoding in LDPC. In some examples, the operation S130 includes: after determining that the target data read fails according to operation S120, determining a reference read voltage according to the number of errors in the read retry scheme, where the reference read voltage may be a reference read voltage corresponding to the case with minimum errors; traversing a log likelihood ratio (LLR) table, where the LLR table is predefined, such as based on the working conditions of the NAND memory device before leaving the factory (such as P/E cycles, retention period, ambient temperature change, etc.), for managing a plurality of offset values and LLR values for reading the target data after each offset; and performing left and right offsets of the reference read voltage within a limited range according to the plurality of offset values obtained by traversal and decoding, so as to repeatedly read the memory to obtain the target data.

In some examples, the predefined LLR table involved in LDPC soft decoding may be determined in the following manner.

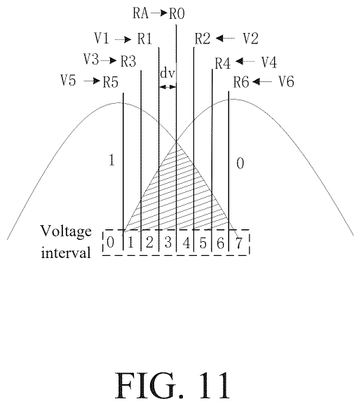

First, any two adjacent distribution states (which may be one erased state and one programmed state, or two adjacent programmed states) are divided into voltage intervals. Take the cross distribution of the threshold voltage of the memory cells shown in FIG. 9 as an example, two adjacent states in the distribution are selected for illustration. As shown in FIG. 11, which shows that seven reads are performed, including a first read R0, a second read R1, a third read R2, a fourth read R3, a fifth read R4, a sixth read R5, and a seventh read R6. The reference read voltages for the first data read R0 can be any reference read voltage of RA, RB, RD, and RE as shown in FIG. 9. Cases for different areas near the reference read voltage are also shown. Take the data reading of LP in the memory 600, and the reference read voltage is RA as shown in FIG. 9 as an example.

The cases for the critical areas near the read voltage are shown in FIG. 11. When the data of LP needs to be read, RA is used as the read voltage to determine the read data: when the threshold voltage of the memory cell is greater than RA, the stored data is 0; otherwise, the stored data is 1. When there is a voltage offset of the threshold voltage of memory cells inside the memory 600, a portion of the memory cells near R0 may expand across RA to another distribution after the voltage offset, and overlapping occurs, as shown in the shaded portion in FIG. 11. The areas with possible overlapping may be subdivided into different voltage intervals, and the voltage values with predetermined offsets (dv) may be increased or decreased sequentially, respectively, with RA as the reference, to form the voltage intervals 0, 1, 2, 3, 4, 5, 6, and 7, as shown in FIG. 11. For the voltage values obtained by incrementally increasing or decreasing the dv around RA, the voltage values are set to be V1, V2, V3, V4, V5, V6, and so on.

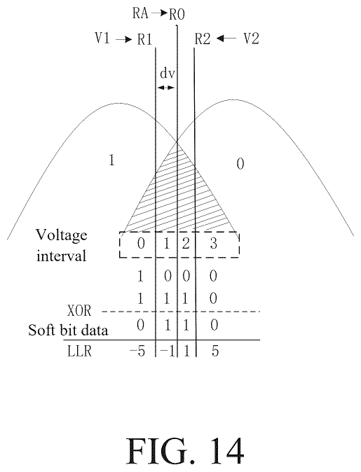

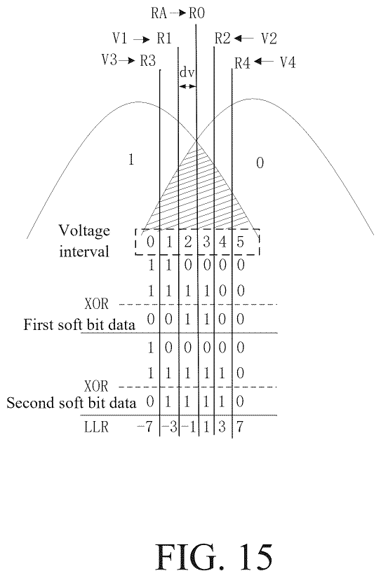

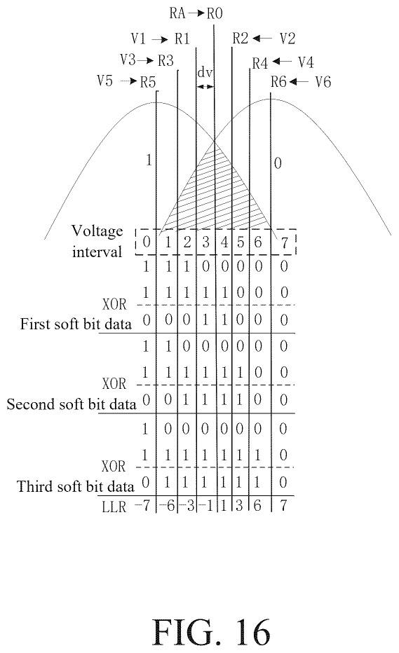

It should be noted here that the division of voltage intervals in this example is only for illustrative purposes and is not limited. The voltage intervals to be divided can be determined according to actual conditions (such as the size of the threshold voltage offset or the size of the overlapping area, etc.). If the threshold voltage offset is small, the number of voltage interval divisions can be reduced. As shown in FIG. 14, two adjacent distribution states are divided into 4 voltage intervals; as shown in FIG. 15, two adjacent distribution states are divided into 6 voltage intervals; and as shown in FIG. 16, two adjacent distribution states are divided into 8 voltage intervals.

As can be seen from FIG. 11, different voltage intervals can be determined using different related voltages. For example, for voltage interval 0, voltage V5 can be used for the determination, and the voltage interval less than V5 is 0; for voltage interval 6, voltages V4 and V6 can be used for the determination, and the voltage interval less than V6 and greater than V4 is voltage interval 6. Therefore, in the design of memory 600, different read voltages after dv offset can be used to determine the value of the voltage interval. For different overlapping areas near RA, the possibility of correctly reading out the data values through V2 or V5 should also be different. Generally speaking, far from the right side of R0, the data is more likely to be “0”; far from the left side of R0, the data is more likely to be “1”.

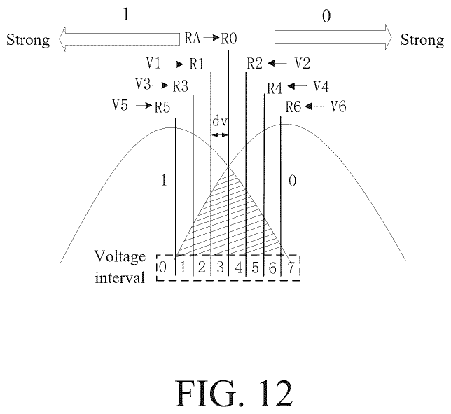

FIG. 12 shows the credibility for different voltage intervals. FIG. 12 shows that the credibility for the read data will be different depending on the distance from the corresponding read determination voltage RA. The closer the area is to the determination voltage RA, such as voltage interval 3 or 4, the more likely the data will be wrong when the voltage changes slightly. Voltage interval 1 or 6 is far away from the read voltage RA, even if the voltage has a larger offset, the read data has a relatively high credibility. Therefore, as shown in FIG. 12, different voltage intervals can be defined as “strong 0 voltage interval” (6), “medium 0 voltage interval” (5), “weak 0 voltage interval” (4) and “strong 1 voltage interval” (1), “medium 1 voltage interval” (2), “weak 1 voltage interval” (3). This means that in the data read after a small range of offset of the read voltage, the error probability of the value in voltage interval 3 or voltage interval 4 is higher, and the error probability of the value in voltage interval 1 or voltage interval 6 is lower.

Regarding the characteristics of the read operation of the memory 600, hard bit data can be read out using reference read voltages (RA, RB, RC, RD, RE, RF and RG as shown in FIG. 9); by offsetting the voltage, a new read voltage including the offset voltage is generated, and soft bit data based on different critical voltage intervals can be read out.

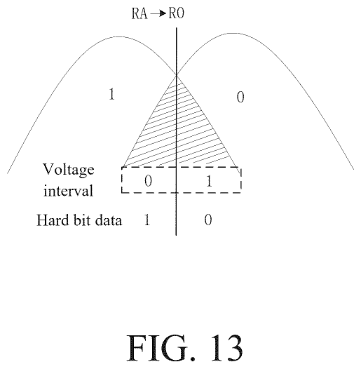

Taking the reference read voltage as RA as an example, as shown in FIG. 13, only the reference read voltage RA is used to read the voltage, and a hard read (1H) is performed to determine the voltage value of the TLC memory cell and read out the data. The data read at this time is the hard bit data.

Taking the reference read voltage as RA as an example, FIG. 14 sets an offset voltage V1 and V2 on each side based on the reference read voltage RA, where V2=RA+dv, V1=RA−dv. At this time, the data reading process is: firstly, set the voltage value to RA, perform a hard read (1H), and read the hard bit data. At this time, the data values of the voltage interval {0, 1, 2, 3} correspond to the hard bit data “1100”;

Then, a soft read (1S) is performed. During the 1S process, the voltage V1 is used as the read voltage to read the data. At this time, the data values of the voltage interval {0, 1, 2, 3} correspond to “1000” respectively. Then the voltage V2 is used as the read voltage to read the data. At this time, the data values of the voltage interval {0, 1, 2, 3} is “1110”. The two sets of data are XORed, e.g., “1000”XOR“1110”, to obtain the soft bit data “0110”.

Next, different quantized LLR (the result of quantizing the LLR) for each voltage interval is set for each voltage interval. According to the position of the voltage interval {0, 1, 2, 3}, it can be known that the error probabilities thereof are different, so different quantized LLR values can be set. As shown in FIG. 14 and Table 1, the quantized LLR of the voltage interval {0, 1, 2, 3} can, but is not limited to, be set to {−5, −1, 1, 5}.

TABLE 1

| LLR voltage interval | 0 | 1 | 2 | 3 |
|---|---|---|---|---|
| Hard bit data | 1 | 1 | 0 | 0 |
| Soft bit data | 0 | 1 | 1 | 0 |
| Quantized LLR | −5 | −1 | 1 | 5 |

For example, assuming that the internal storage voltage value of the TLC memory cell P is in voltage interval 3, although it cannot be directly measured, after the soft bit data is read and generated in FIG. 14, the external data value is represented as the hard bit data of 0, soft bit data of 0, and LLR quantization value of 5. Therefore, it can be determined that the voltage of the TLC memory cell is far from the critical value, and the possibility of the data being “0” is very high. If the internal storage voltage value of TLC memory cell Q is in voltage interval 1, the external data value is represented as the hard bit data of 1, soft bit data of 1, and LLR quantization value of −1, the possibility of the data being “1” is relatively low.

Taking the reference read voltage as RA as an example, in FIG. 15, two offset voltages V2/V4 and V1/V3 are set on each side based on the read voltage RA, where V2=RA+dv, V4=RA+2dv, V1=RA−dv, V3=RA−2dv. At this time, the data reading process is as in other figures: firstly, set the voltage value to RA, perform a hard read (1H), and read the hard bit data. At this time, the data value of the voltage interval {0, 1, 2, 3, 4, 5} is the hard bit data “111000”.

Then, two soft reads (2S) are performed. In the 2S process, firstly, the voltage V1 is used as the read voltage to read the data. At this time, the data value of the voltage interval {0, 1, 2, 3, 4, 5} is “110000”. Secondly, the voltage V2 is used as the read voltage to read the data. At this time, the data value of the voltage interval {b3, b2, b1, a1, a2, b3} is “111100”, and the two sets of data are XORed, e.g., “110000”XOR“111100”, to obtain first soft bit data “001100”. Again, use voltage V3 as the read voltage to read data. At this time, the data value of the voltage interval {0, 1, 2, 3, 4, 5} is “100000”. Finally, use voltage V4 as the read voltage to read data. At this time, the data value of the voltage interval {0, 1, 2, 3, 4, 5} is “111110”, and the two sets of data are XORed, e.g., “100000”XOR“111110”, to obtain second soft bit data “011110”.

In this way, based on two soft reads, the first soft bit data “001100” and second soft bit data “011110” can be obtained. After “1” (2 or 3 area) in the first soft bit data indicates an area with low credibility, the “1” in the second soft bit data is used to continue positioning, and an area with medium credibility can be further obtained. In this way, through two soft bit data generations, 6 voltage intervals {0, 1, 2, 3, 4, 5} can be located.

According to the above discussion and the position of the voltage interval {0, 1, 2, 3, 4, 5}, different quantized LLR values can be set. As shown in FIG. 15 and Table 2, the quantized LLR of the voltage interval {0, 1, 2, 3, 4, 5} can be set to {−7, −3, −1, 1, 3, 7}.

TABLE 2

| LLR voltage interval | 0 | 1 | 2 | 3 | 4 | 5 |
|---|---|---|---|---|---|---|
| Hard bit data | 1 | 1 | 1 | 0 | 0 | 0 |
| First soft bit data | 0 | 0 | 1 | 1 | 0 | 0 |
| Second soft bit data | 0 | 1 | 1 | 1 | 1 | 0 |
| Quantized LLR | −7 | −3 | −1 | 1 | 3 | 7 |

Taking the reference read voltage RA as an example, in FIG. 16, two offset voltages V2/V4/V6 and V1/V3/V5 are set on each side based on the read voltage RA, where V2=RA+dv, V4=RA+2dv, V6=RA+3dv, V1=RA−dv, V3=RA−2dv, V5=RA−3dv. Similarly, the quantized LLR of the voltage interval {0, 1, 2, 3, 4, 5, 6, 7} can be obtained, as shown in FIG. 16 and Table 3.

TABLE 3

| LLR voltage interval | 0 | 1 | 2 | 3 | 4 | 5 | 6 | 7 |
|---|---|---|---|---|---|---|---|---|
| Hard bit data | 1 | 1 | 1 | 1 | 0 | 0 | 0 | 0 |
| First soft bit data | 0 | 0 | 0 | 1 | 1 | 0 | 0 | 0 |
| Second soft bit data | 0 | 0 | 1 | 1 | 1 | 1 | 0 | 0 |
| Third soft bit data | 0 | 1 | 1 | 1 | 1 | 1 | 1 | 0 |
| Quantized LLR | −7 | −6 | −3 | −1 | 1 | 3 | 6 | 7 |

According to FIG. 13, FIG. 14, FIG. 15, FIG. 16, Table 1, Table 2 and Table 3, a quantized LLR table as shown in Table 4 can be obtained. The quantized LLR table as shown in Table 4 can be stored in the controller 11200 or loaded into the controller 11200 after the memory system 11000 is started. In the LDPC soft decoding process, the pre-set LLR table is used to input the original LLR value to the LDPC for decoding, thereby improving the efficiency of LDPC decoding.

TABLE 4

| LLR voltage interval | 0 | 1 | 2 | 3 | 4 | 5 | 6 | 7 | . . . |
|---|---|---|---|---|---|---|---|---|---|
| 1H1S | −5 | 0 | 0 | −1 | 1 | 0 | 0 | 5 | . . . |
| 1H2S | −7 | 0 | −3 | −1 | 1 | 3 | 0 | 7 | . . . |
| 1H3S | −7 | −6 | −3 | −1 | 1 | 3 | 6 | 7 | . . . |

In a third example, the target data is obtained by executing an internal RAID. In some examples, as shown in FIG. 10, after the operation S130, operation S140 is executed to obtain the target data according to check bits of the target data. In some examples, the operation S140 includes: after determining that the reading of the target data fails according to S130, performing an XOR process on the target data, and writing the target data and the check bit of the target data together into the user data area. If one set of the target data is lost, the lost target data can be inferred from other sets of target data and the check bits of the target data. However, when two or more sets of target data are lost, the lost target data cannot be recovered through RAID.

In the above three error checking and correction methods, when performing LDPC soft decoding, the pre-set LLR table is difficult to match all working conditions of the NAND memory device and the current state of the NAND memory device, thereby reducing the performance and efficiency of the LDPC soft decoding, resulting in the need to perform internal RAID to obtain target data, resulting in low data reading efficiency and large delay.

In order to improve the efficiency of error checking and correction of read data by the controller 11200 and reduce the data read delay, the present disclosure provides an implementation in which the predefined LLR table is optimized according to the current working conditions and status of the memory 11100. The optimized LLR table is able to more closely reflect the true characteristics of the storage medium, thereby significantly improving the matching between the LLR table and the memory 11100, improving the performance and efficiency of LDPC soft decoding, and also reducing data read delay caused by obtaining the target data by performing the internal RAID.

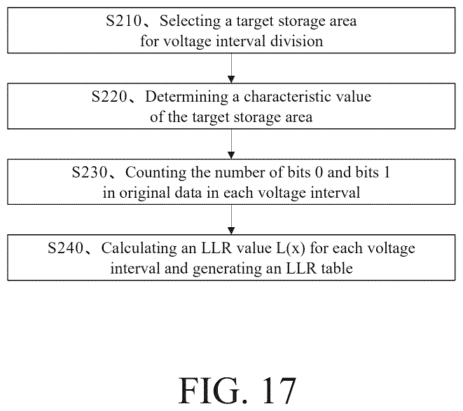

As shown in FIG. 17, an LLR table optimization implementation method provided by the present disclosure includes operation S210 to S240:

S210: Selecting a target storage area for voltage interval division.

In some examples, the target storage area may be page 620 in the memory 11100 that meets a preset condition. The preset condition that the target storage area meets may include the following two conditions:

First, the data stored in the target storage area has not been subjected to RAID reconstruction, because if the data enters the RAID process, it means that the memory 11100 itself may have physical damage, which is difficult to overcome by optimizing LDPC soft decoding.

Second, the target data can be obtained by performing LDPC soft decoding on the data read from the target storage area. The reason why the LLR table used in LDPC soft decoding needs to be optimized, when the target data can be obtained by performing LDPC soft decoding on the data read from the target storage area, is mainly considered as follows:

When the decoded data is obtained after a number of first iterations of performing soft decoding on the data read from the target storage area using the LLR table corresponding to 1H1S, if the number of the first iterations is greater than the first preset threshold, the LLR table corresponding to 1H1S should be optimized in order to reduce the number of decoding iterations, improve decoding efficiency, and reduce data read delay.

When the data read from the target storage area fails to be soft-decoded using the LLR table corresponding to 1H1S, the LLR table corresponding to 1H2S is used for soft decoding. When the LLR table corresponding to 1H2S is used for soft decoding and the decoded data is obtained after a number of second iterations, if the number of second iterations is less than a second preset threshold, it indicates that the deviation of the coded data from the correct data is not very large, and the LLR table corresponding to 1H1S can be optimized so that the decoding can be performed successfully using the optimized LLR table corresponding to 1H1S, thereby reducing the number of decoding iterations and improving the decoding efficiency. If the second number of iterations is greater than the second preset threshold, it indicates that the deviation of the coded data from the correct data is large, and the LLR table corresponding to 1H2S is optimized, thereby reducing the number of decoding iterations and improving the decoding efficiency. While optimizing the LLR table corresponding to 1H2S, the LLR table corresponding to 1H1S is also optimized. However, if the LLR table corresponding to 1H2S is directly optimized when the number of second iterations is less than the second preset threshold, the amount of data to be read will be large and take up more time, affecting the working efficiency of the memory 11100.

Similarly, when the data read from the target storage area fails to be soft-decoded using the LLR tables corresponding to 1H1S and 1H2S, the LLR table corresponding to 1H3S is used for soft decoding. When the decoded data is obtained after a number of third iterations, if the number of third iterations is less than a third preset threshold, the LLR table corresponding to 1H2S is optimized (the LLR table corresponding to 1H1S is also optimized). If the number of third iterations is greater than the third preset threshold, the LLR table corresponding to 1H3S is optimized (the LLR tables corresponding to 1H1S and 1H2S are also optimized).

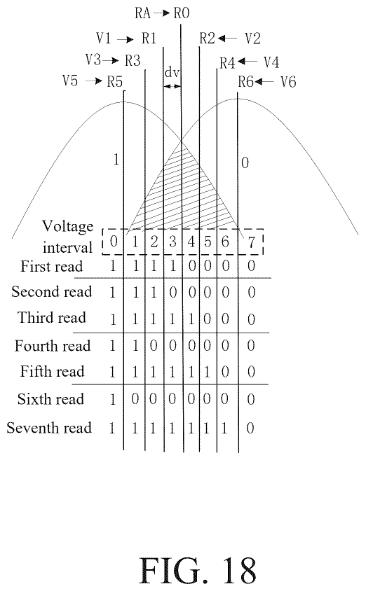

In some examples, voltage interval division is performed by a plurality of data readings. Taking each memory cell 606 of the memory as an example in which three bits of data are stored, the target storage area may be MP, CP and LP in the memory. As shown in FIG. 18 and Table 5, the plurality of data readings (RA, V1, V2, V3, V4, V5, V6) are performed according to a reference read voltage (any reference read voltage of RA, RB, RC, RD, RE, RF and RG as shown in FIG. 9, taking RA as an example) and the plurality of voltage offsets (such as −8, +8, −16, +16, −24, +24) to obtain plurality of sets of data. Based on the plurality of sets of data, a plurality of voltage intervals to which the threshold voltage of the memory cells in the target storage area belong are determined. The voltage interval is an interval in which the data bit in two adjacent groups of data is flipped, for example, the voltage interval is to characterize that the data read twice consecutively at the same position in the target storage area has a bit flip (flipped from 1 to 0 or from 0 to 1).

In some examples, when determining the plurality of voltage intervals (bit flip intervals), in Table 5, when performing the first read R0 based on the read voltage RA, the data of the memory cell with a threshold voltage less than the read voltage RA is “1”, and the data of the memory cell with a threshold voltage greater than the read voltage RA is “0”, and two adjacent distribution states can be divided into two voltage intervals, e.g., voltage interval 0 and voltage interval 1. When performing the second read R1 based on the read voltage V1, the data of the memory cell with a threshold voltage less than the read voltage V1 is “1”, and the data of the memory cell with a threshold voltage greater than the read voltage V1 is “0”. The data obtained by the first read R0 and the second read R3 will determine the position where the flip from 1 (0) to 0 (1) occurs as a voltage interval, for example, the voltage interval 1 corresponding to 2 in a row of the second read R3 in Table 5 is flipped from 1 to 0, and the voltage interval division is further refined. When the third read R4 is performed based on the reading voltage V2, the data of the memory cell with a threshold voltage less than the reading voltage V2 is “1”, and the data of the memory cell with a threshold voltage greater than the reading voltage V2 is “0”. The data obtained by the second R3 read and the third R4 read will determine the position where the flip from 1 (0) to 0 (1) occurs as a voltage interval, for example, as shown in Table 5, the voltage interval 2 corresponding to 3 in a row of the third read R4 is flipped from 0 to 1, and the voltage interval division is further refined. Therefore, the 1H1S reading method can determine 4 voltage intervals from voltage interval 0 to voltage interval 3. Similarly, the 1H2S reading method can determine 6 voltage intervals from voltage interval 0 to voltage interval 5. The 1H3S reading method can determine 8 voltage intervals from voltage interval 0 to voltage interval 7.

TABLE 5

| Voltage interval | | | 0 | | | | 1 | | | |
|---|---|---|---|---|---|---|---|---|---|---|
| 1H | First read | R0 (RA) | 1 | 1 | 1 | 1 | 0 | 0 | 0 | 0 |
| Voltage interval | | | 0 | | | 1 | 2 | 3 | | |
| 1H1S | Second Read | R1 (RA − 8) | 1 | 1 | 1 | 2 | 0 | 0 | 0 | 0 |
| | Third Read | R2 (RA + 8) | 1 | 1 | 1 | 2 | 3 | 0 | 0 | 0 |
| Voltage interval | | | 0 | | 1 | 2 | 3 | 4 | 5 | |
| 1H2S | Fourth Read | R3 (RA − 16) | 1 | 1 | 4 | 2 | 3 | 0 | 0 | 0 |
| | Fifth Read | R4 (RA + 16) | 1 | 1 | 4 | 2 | 3 | 5 | 0 | 0 |
| Voltage interval | | | 0 | 1 | 2 | 3 | 4 | 5 | 6 | 7 |
| 1H3S | Sixth Read | R5 (RA − 24) | 1 | 6 | 4 | 2 | 3 | 5 | 0 | 0 |
| | Seventh Read | R6 (RA + 24) | 1 | 6 | 4 | 2 | 3 | 5 | 7 | 0 |

The plurality of data reading methods may include any one of the following reading methods: a TLC mode reading method and an single level read (SLR) reading method.

In one example, in the TLC mode reading method, due to the different encoding methods used, the TLC mode includes a plurality of reading methods, which may include 124 (e.g., read LP for one time, read CP for two times, and read MP for four times) and 232 (e.g., read LP for two times, read CP for three times, and read MP for two times). The controller 11200 sends a first read instruction to the memory 11100, and the first read instruction includes an address, a reference read voltage, and a voltage offset of a first storage area of the memory 11100. The address of the first storage area is the address of the target storage area.

The 124 reading method will be used for the distribution state shown in FIG. 7 is, where LP is read for one time using the reference read voltage RD, CP needs to be determined by reading two times using the reference read voltage RB and the reference read voltage RF, and MP needs to be determined by reading four times by the reference read voltage RA, the reference read voltage RC, the reference read voltage RE, and the reference read voltage RG.

The 232 reading method will be used for the distribution state shown in FIG. 8, where LP is read for two times using the reference read voltage RA and reference read voltage RE, CP needs to be determined by reading three times using reference read voltage RB, reference read voltage RD and reference read voltage RF, and MP needs to be determined by reading two times using reference read voltage RC and reference read voltage RG. The encoding methods of different programming states can be determined according to actual conditions.

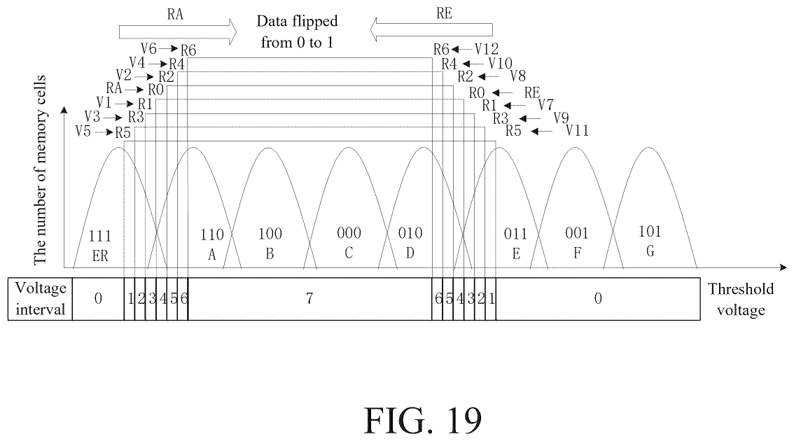

As shown in FIG. 19, taking using 232 for the distribution state shown in FIG. 8 to read the LP in the memory 11100 as an example, the controller 11200 sends a first read instruction to the memory 11100, where the first read instruction includes a first reference read voltage, a second reference read voltage, a first voltage offset, and a second voltage offset, the first reference read voltage is offset based on the first voltage offset, and the second reference read voltage is offset based on the second voltage offset.

In some examples, when a first data read R0 is performed, the first read instruction includes a first reference read voltage of RA, a first voltage offset of 0, a second reference read voltage of RE, and a second voltage offset of 0, thereby obtaining a first set of data.

When a second data read R1 is performed, the first read instruction includes the first reference read voltage of RA, the first voltage offset indicating that the first reference read voltage RA is offset to V1, the second reference read voltage of RE, the second voltage offset indicating that the second reference read voltage RE is offset to V7, thereby obtaining the second set of data.

When a third data read R2 is performed, the first read instruction includes the first reference read voltage of RA, the first voltage offset indicating that the first reference read voltage RA is offset to V2, the second reference read voltage of RE, the second voltage offset indicating that the second reference read voltage RE is offset to V8, thereby obtaining the third set of data.

In some examples, when the third data read R2 is performed, the first read instruction includes the first reference read voltage of V1, the first voltage offset indicating that the first reference read voltage V1 is offset to V2, the second reference read voltage of V7, the second voltage offset indicating that the second reference read voltage V7 is offset to V8, thereby obtaining the third set of data.

The fourth data read R3, the fifth data read R4, the sixth data read R5 and the seventh data read R6 are similar and are not repeated here.

According to the flipping of data bit 0 and data bit 1, a plurality of voltage intervals (bit flipping intervals) to which the threshold voltages of the memory cells in the target storage area belong are determined, which involves the merging of bit flipping intervals. For example, if the predefined LLR voltage intervals are 8 (voltage intervals 0, 1, 2, 3, 4, 5, 6, 7), the same bit flipping intervals can be merged into one voltage interval after the controller 11200 sends a read instruction. For example, if the first data read R0 is performed using the reference read voltage RA or RE, the voltage intervals 0, 1, 2, 3 can be merged into one voltage interval, and the voltage intervals 4, 5, 6, 7 can be merged into one voltage interval. When the second data read R1 is performed, the reading voltage is V1 (the reference read voltage RA is offset in the negative direction) or V7 (the reference read voltage RE is offset in the positive direction), then the voltage intervals 0, 1, and 2 can be merged into one voltage interval, and the voltage intervals 3, 4, 5, 6, and 7 can be merged into one voltage interval. When the third data read R2 is performed, the reading voltage is V2 (the reference read voltage RA is offset in the positive direction) or V8 (the reference read voltage RE is offset in the negative direction), then the voltage intervals 0, 1, 2, 3, and 4 can be merged into one voltage interval, and the voltage intervals 5, 6, and 7 can be merged into one voltage interval. Then after three readings (1H1S), the voltage intervals 0, 1, 2, 3, 4, 5, 6, and 7 can be merged into 4 voltage intervals. As shown in Table 6, voltage intervals 0, 1, and 2 are merged into one voltage interval 0, voltage interval 3 is one voltage interval 3, voltage interval 4 is one voltage interval 4, and voltage intervals 5, 6, and 7 are merged into one voltage interval 7. The same is true for 1H2S and 1H3S, as shown in Table 6. It should be noted that serial numbers are given when the voltage intervals are divided, and the serial numbers may be discontinuous after merging. This is only for the convenience and clarity of the explanation, and does not mean that it should be set in this way in actual applications.

The division of the voltage intervals is related to the number of data reading times or the offset voltage. For example, the more the number of data reading times is, the smaller the granularity of the voltage interval division is; and the smaller the offset voltage is, the smaller the granularity of the voltage interval division is.

TABLE 6

| LLR voltage interval | 0 | 1 | 2 | 3 | 4 | 5 | 6 | 7 |
|---|---|---|---|---|---|---|---|---|
| 1H1S | 0 + 1 + 2 | \ | \ | 3 | 4 | \ | \ | 5 + 6 + 7 |
| 1H2S | 0 + 1 | \ | 2 | 3 | 4 | 5 | \ | 7 |
| 1H3S | 0 | 1 | 2 | 3 | 4 | 5 | 6 | 7 |

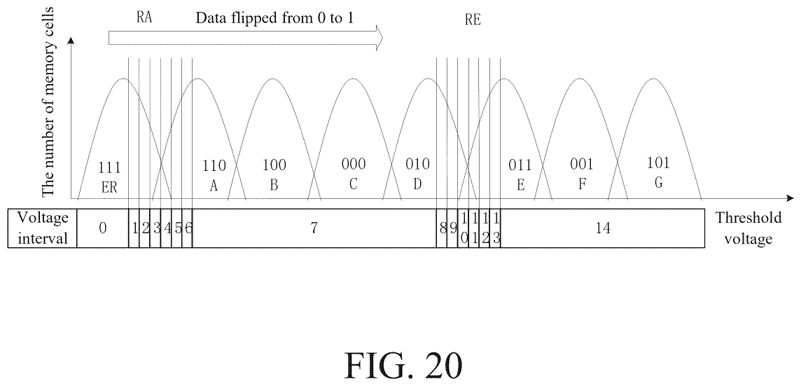

In another example, taking reading the LP in the memory 11100 using the SLR reading method as an example, as shown in FIG. 20, the controller 11200 sends a data reading instruction to the memory 11100, and the reading instruction includes a reference read voltage and a voltage offset, and the reference read voltage is offset based on the voltage offset. For example, the instruction includes a reference read voltage RA and a voltage offset indicating the offset of the reference read voltage RA, or the instruction includes a reference read voltage RE and an offset indicating the voltage offset of the reference read voltage RE. Compared with the TLC mode reading method, in the SLC mode reading method, the data reading instruction sent by the controller 11200 to the memory 11100 only includes one reference voltage and an offset, so the time used by the SLR reading method is shorter than that of the TLC mode reading method.

According to the flipping of data bit 0 and data bit 1, the bit flipping interval is determined, which also involves the merging of bit flipping intervals, as shown in Table 7. The specific merging method is similar to the scheme shown in Table 6 and will not be repeated here.

TABLE 7

| LLR voltage interval | 0 | 1 | 2 | 3 | 4 | 5 | 6 | 7 |
|---|---|---|---|---|---|---|---|---|
| 1H1S | 0 + 14 + 1 + | \ | \ | 3 + 11 | 4 + 10 | \ | \ | 5 + 9 + 6 + |
| | 13 + 2 + 12 | | | | | | | 8 + 7 |
| 1H2S | 0 + 14 + 1 + 13 | \ | 2 + 12 | 3 + 11 | 4 + 10 | 5 + 9 | \ | 6 + 8 + 7 |
| 1H3S | 0 + 14 | 1 + 13 | 2 + 12 | 3 + 11 | 4 + 10 | 5 + 9 | 6 + 8 | 7 |

S220: Determine a characteristic value of the target storage area.

In some examples, the characteristic value can be used to characterize the distribution characteristics of memory cells in different states in the current storage area. When determining the characteristic value of the storage area, it can be determined based on the distribution characteristics of memory cells in different states in the storage area. The distribution characteristics of memory cells in different states in the storage area are normally distributed, but the working conditions of the memory cells will be affected by the data storage time and the number of write/erase (P/E) times, and the distribution characteristics of memory cells in different states will no longer be completely normally distributed.

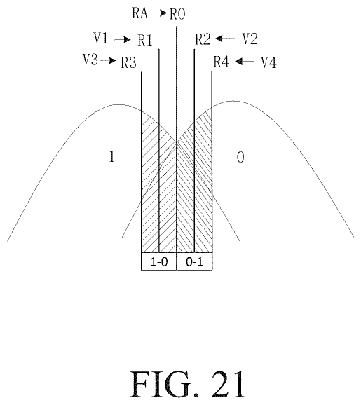

Taking the 1H2S reading method as an example, as shown in FIG. 21, the distribution characteristics of the memory cells in different states in the storage area in the memory 11100 are normally distributed, and the critical area near the read voltage is symmetrical based on the reference read voltage (taking RA as an example). The number of memory cells whose encoded data is flipped from 1 to 0 (1-0) and the number of memory cells whose encoded data is flipped from 0 to 1 (0-1) on both sides of the symmetry are roughly equal.

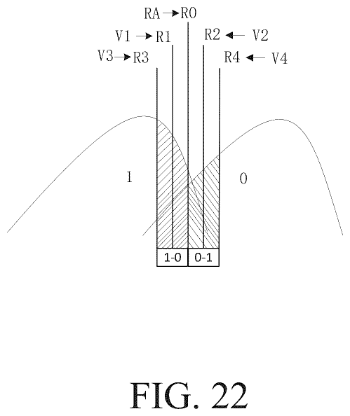

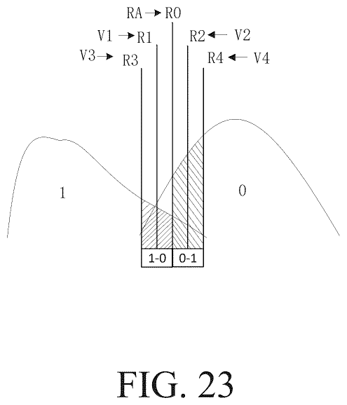

As shown in FIG. 22 or FIG. 23, the distribution characteristics of the memory cells in different states in the storage area are no longer completely normally distributed. As shown in FIG. 22, the critical area near the read voltage is on the left side of the reference read voltage RA, and the number of memory cells whose encoded data is flipped from 1 to 0 (1-0) is greater than the number of memory cells whose encoded data is flipped from 0 to 1 (0-1) on the right side of the reference read voltage RA. As shown in FIG. 22, the critical area near the read voltage is on the left side of the reference read voltage RA, and the number of memory cells whose encoded data is flipped from 1 to 0 (1-0) is less than the number of memory cells whose encoded data is flipped from 0 to 1 (0-1) on the right side of the reference read voltage RA.

It can be seen from this that the distribution characteristics of the memory cells in different states in the storage area in the memory 11100 can embody or reflect the current state of the storage area in the memory 11100.

The characteristic values can be defined as:

$$characteristic value = \frac{\begin{matrix}The number of memory cells \\ whose read data flips from 1 to 0 ( 1 - 0 )\end{matrix}}{\begin{matrix}The number of memory cells \\ whose read data flips from 0 to 1 ( 0 - 1 )\end{matrix}}$$

As shown in Table 8, the characteristic value a of the distribution characteristic shown in FIG. 21 is approximately equal to 1. The characteristic value b of the distribution characteristic shown in FIG. 22 is approximately equal to 2. The characteristic value c of the distribution characteristic shown in FIG. 23 is approximately equal to 0.5.

TABLE 8

| | | | | | | |
|---|---|---|---|---|---|---|
| characteristic value | a | b | c | \ | \ | . . . |

Each characteristic value can correspond to a plurality of LLR tables (1H1S, 1H2S, 1H3S). As shown in Table 9, take the characteristic value a as an example.

TABLE 9
Characteristic value = a

| LLR voltage interval | 0 | 1 | 2 | 3 | 4 | 5 | 6 | 7 | . . . |
|---|---|---|---|---|---|---|---|---|---|
| 1H1S | −5 | 0 | 0 | −1 | 1 | 0 | 0 | 5 | . . . |
| 1H2S | −7 | 0 | −3 | −1 | 1 | 3 | 0 | 7 | . . . |
| 1H3S | −7 | −6 | −3 | −1 | 1 | 3 | 6 | 7 | . . . |

S230: Counting the number of bits 0 and bits 1 in original data in each voltage interval.

In some examples, decoded data (or target data) may be obtained by performing LDPC soft decoding on the original data as shown in operation S130, including but not limited to performing the soft decoding based on 1H1S LLR table, or 1H2S LLR, or 1H3S LLR table.

S240: Calculating an LLR value L(x) for each voltage interval and generating an LLR table.

In some examples, L(x) can be calculated by the following formula (1):

$$L ( x ) = log \frac{p ( x = 0 )}{p ( x = 1 )} \qquad Formula ( 1 )$$

Among them, p(x=0) represents the probability of bit 0 in the original programmed data x; p(x=1) represents the probability of bit 1 in the original programmed data x.

By performing quantization on L(x), the quantized LLR can be obtained.

S250: Classifying the LLR tables according to the characteristic values of the storage areas to form an LLR table pool.

In some examples, as shown in Table 8, the LLR table pool includes a plurality of characteristic values. Each characteristic value includes a plurality of LLR tables, as shown in Table 9.

In some examples, when the LLR table is optimized according to the current state of a storage area in memory 11100, if the characteristic value d of the current storage area is not in the LLR table pool shown in Table 8, the characteristic value d and the corresponding LLR table are added to the table pool, as shown in Table 10.

TABLE 10

| | | | | | | |
|---|---|---|---|---|---|---|
| Characteristic value | a | b | c | d | \ | . . . |

If the characteristic value of the current storage area exists in the LLR table pool as shown in Table 8, the optimized LLR table corresponding to the characteristic value is updated to the table pool.

Through the above-mentioned example, after optimizing the LLR table pre-defined in the LDPC soft decoding, when the controller 11200 decodes the data read out from the memory 11100, it first determines the characteristic value of the storage area where the read data is located, and then selects the corresponding LLR table in the optimized LLR table pool according to the characteristic value to decode the read data to obtain decoded data or target data.

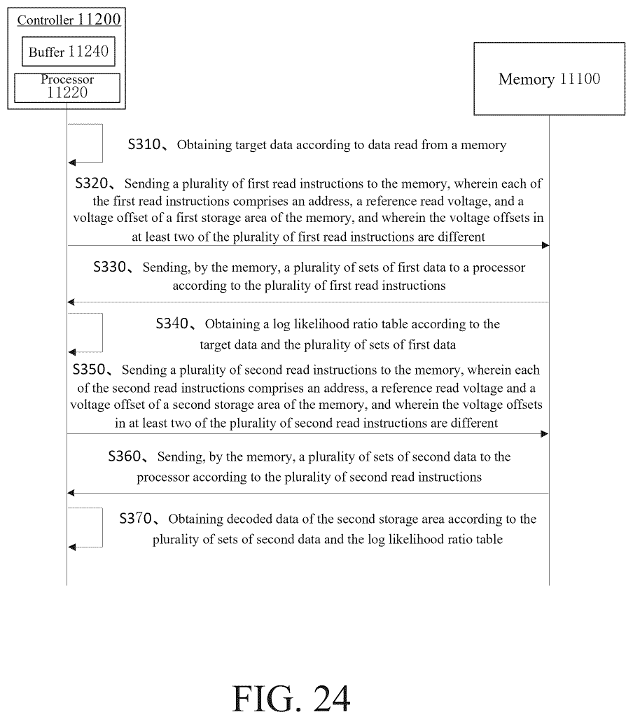

Based on the electronic device, memory system, controller and memory shown in FIG. 1, FIG. 2, FIG. 3, FIG. 4, FIG. 5 and FIG. 6, a method of operating the controller including the following S310 to S370 as shown in FIG. 24 can be implemented, and include:

S310, obtaining target data according to data read from a memory.

In some examples, as shown in FIG. 2, the controller 11200 includes at least a buffer 11240 and a processor 11220, where the buffer 11240 is coupled to the processor 11220. The processor 11220 can obtain the target data through the LDPC soft decoding shown in S130, including but not limited to soft decoding based on a 1H1S LLR table, a 1H2S LLR table, or a 1H3S LLR table.

S320, sending a plurality of first read instructions to the memory, where each of the first read instructions includes an address, a reference read voltage, and a voltage offset of a first storage area of the memory, and where the voltage offsets in at least two of the plurality of first read instructions are different.

In some examples, as shown in FIG. 19, the first read instruction may include a first reference read voltage, a second reference read voltage, a first voltage offset, and a second voltage offset; the first reference read voltage is offset based on the first voltage offset; and the second reference read voltage is offset based on the second voltage offset. For details, please refer to the example shown in FIG. 19, which will not be described in detail here.

In some examples, as shown in FIG. 20, the first read instruction may include a reference read voltage and a voltage offset, and the reference read voltage is offset based on the voltage offset. For details, please refer to the example shown in FIG. 20, which will not be described in detail here.

In some examples, the address of the first storage area is used to determine the target storage area in S210. The data stored in the first storage area has not been subjected to redundant array of independent disks (RAID) reconstruction. For details, please refer to the example shown in S210, which will not be repeated here.

S330: Sending, by the memory, a plurality of sets of first data to a processor according to the plurality of first read instructions.

In some examples, specific reference may be made to the examples shown in FIG. 19 or FIG. 20, where the plurality of sets of first data include a first set of data, a second set of data, and a third set of data, etc., which will not be described in detail here.

S340: Obtaining a log likelihood ratio table according to the target data and the plurality of sets of first data.

In some examples, based on plurality of sets of first data, a plurality of voltage intervals to which the threshold voltages of the memory cells in the first storage area belong are determined. The voltage interval is an interval in which data bits in two adjacent sets of first data are flipped. For details, please refer to the example shown in FIG. 18 and Table 5.

In some examples, if the plurality of sets of first data include at least a first set of data and a second set of data, the threshold voltage in the first storage area is partitioned according to the first set of data to obtain a first partition result; the threshold voltage in the first storage area is partitioned according to the second set of data to obtain a second partition result; the plurality of voltage intervals to which the threshold voltages of the memory cells in the first storage area belongs is determined based on the first partition result and the second partition result.

In some examples, as shown in FIG. 18 and Table 5, the first set of data may be data 11110000 read when the first reading is performed based on the read voltage RA. According to the first set of data 11110000, the threshold voltage in the first storage area is partitioned to obtain two voltage intervals, which are the voltage interval in which the memory cell with a threshold voltage of “1” is located and the voltage interval in which the memory cell with a threshold voltage of 0 is located. The second set of data may be data 11100000 read when the second reading is performed based on the read voltage V1, and two voltage intervals are obtained. According to the second set of data 11100000, two voltage intervals are obtained, which are the voltage interval in which the memory cell with a threshold voltage of “1” is located and the voltage interval in which the memory cell with a threshold voltage of 0 is located. The position flipped from 1 (0) to 0 (1) in the first set of data 11110000 and the second set of data 11100000 is determined as a voltage interval again, and a plurality of voltage intervals to which the threshold voltages of the memory cells in the first storage area belongs are obtained.

Of course, the first set of data may also be data read when the second reading is performed based on the reading voltage V1, and the second set of data may also be data read when the third reading is performed based on the reading voltage V2. For details, please refer to the example shown in FIG. 18 and Table 5.

In some examples, the characteristic value of the first storage area is determined according to a plurality of voltage intervals of the threshold voltage in the first storage area.

In some examples, reference may be made to the examples shown in FIG. 21, FIG. 22, and FIG. 23.

In some examples, a log likelihood ratio of each voltage interval is obtained according to the target data and a plurality of voltage intervals of the threshold voltage in the first storage area.

In some examples, reference may be made to the example shown in operation S240.

In some examples, a log likelihood ratio table is obtained according to the log likelihood ratio of each voltage interval of the threshold voltage in the first storage area and the characteristic value of the first storage area.

In some examples, reference may be made to the example shown in operation S240.

S350, sending a plurality of second read instructions to the memory, where each of the second read instructions includes an address, a reference read voltage and a voltage offset of a second storage area of the memory, and where the voltage offsets in at least two of the plurality of second read instructions are different.

In some examples, the execution process of operation S350 is similar to that of operation S320, and reference may be made to the example shown in operation S320.

S360: Sending, by the memory, a plurality of sets of second data to the processor according to the plurality of second read instructions.

In some examples, the execution process of operation S360 is similar to that of operation S330, and reference may be made to the example shown in operation S330.

S370: obtaining decoded data of the second storage area according to the plurality of sets of second data and the log likelihood ratio table.

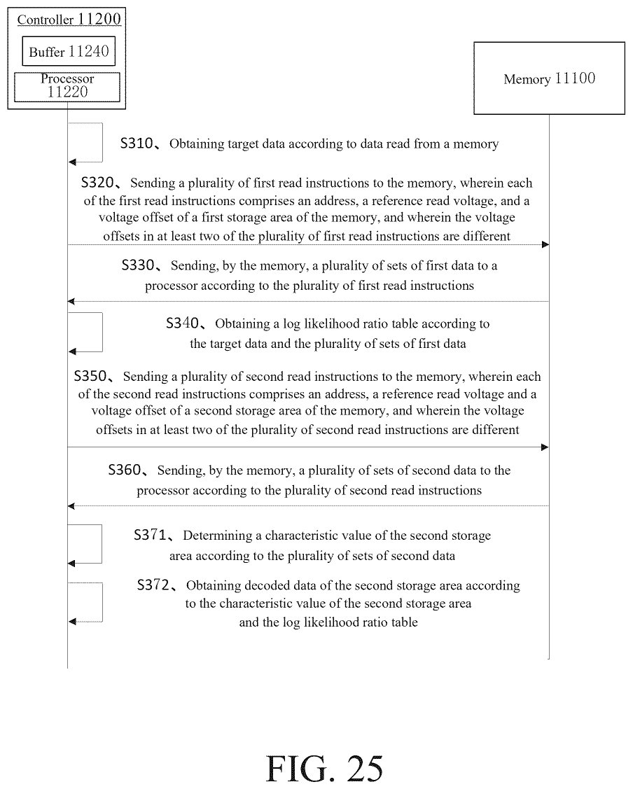

In some examples, as shown in FIG. 25, operation S370 includes operations S371-S372:

S371: Determining a characteristic value of the second storage area according to the plurality of sets of second data;

In some examples, the determination of the characteristic value of the second storage area may refer to the examples shown in FIG. 21, FIG. 22, and FIG. 23.

S372: Obtaining decoded data of the second storage area according to the characteristic value of the second storage area and the log likelihood ratio table.

In some examples, after optimizing the pre-defined LLR table in the LDPC soft decoding, when the controller 11200 decodes the data read out from the memory 11100, it first determines the characteristic value of the storage area where the read data is located, and then selects the corresponding LLR table in the optimized LLR table pool according to the characteristic value to decode the read data to obtain decoded data or target data.

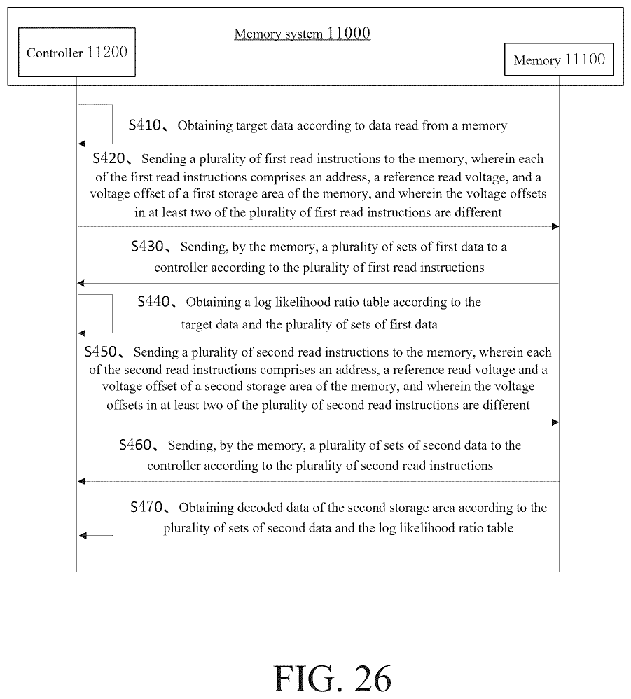

Based on the electronic device, memory system and memory shown in FIG. 1, FIG. 2, FIG. 3, FIG. 4, FIG. 5 and FIG. 6, an operation method of the memory system including the following operations S410 to S470 as shown in FIG. 26 can be implemented, where the method includes:

S410: Obtaining target data according to data read from a memory.

In some examples, as shown in FIG. 1, FIG. 2, FIG. 3, and FIG. 4, the memory system 11000 includes a controller 11200 and a memory 11100, and the controller 11200 is coupled to the memory 11100. The controller 11200 can obtain the target data through the LDPC soft decoding shown in operation S130, including but not limited to soft decoding based on a 1H1S LLR table, or a 1H2S LLR, or a 1H3S LLR table.

S420: Sending a plurality of first read instructions to the memory, where each of the first read instructions includes an address, a reference read voltage, and a voltage offset of a first storage area of the memory, and where the voltage offsets in at least two of the plurality of first read instructions are different.

In some examples, as shown in FIG. 19, the first read instruction may include a first reference read voltage, a second reference read voltage, a first voltage offset, and a second voltage offset; the first reference read voltage is offset based on the first voltage offset; and the second reference read voltage is offset based on the second voltage offset. For details, please refer to the example shown in FIG. 19, which will not be described in detail here.

In some examples, as shown in FIG. 20, the first read instruction may include a reference read voltage and a voltage offset, and the reference read voltage is offset based on the voltage offset. For details, please refer to the example shown in FIG. 20, which will not be described in detail here.

In some examples, the address of the first storage area is used to determine the target storage area in operation S210. The data stored in the first storage area has not been subjected to redundant array of independent disks RAID reconstruction. For details, please refer to the example shown in S210, which will not be repeated here.

S430: Sending, by the memory, a plurality of sets of first data to a controller according to the plurality of first read instructions.

In some examples, specific reference may be made to the examples shown in FIG. 19 or FIG. 20, where the plurality of sets of first data include a first set of data, a second set of data, and a third set of data, etc., which will not be described in detail here.

S440: Obtaining a log likelihood ratio table according to the target data and the plurality of sets of first data.

In some examples, based on plurality of sets of first data, a plurality of voltage intervals to which the threshold voltages of the memory cells in the first storage area belong are determined. The voltage interval is an interval in which data bits in two adjacent sets of first data are flipped. For details, please refer to the example shown in FIG. 18 and Table 5.

In some examples, if the plurality of sets of first data include at least a first set of data and a second set of data, the threshold voltage in the first storage area is partitioned according to the first set of data to obtain a first partition result; the threshold voltage in the first storage area is partitioned to according to the second set of data to obtain a second partition result; based on the first partition result and the second partition result, determine the plurality of voltage intervals to which the threshold voltage of the memory cell in the first storage area belongs.

In some examples, as shown in FIG. 18 and Table 5, the first set of data may be data 11110000 read when the first reading is performed based on the read voltage RA. According to the first set of data 11110000, the threshold voltage in the first storage area is partitioned to obtain two voltage intervals, which are the voltage interval in which the memory cell with a threshold voltage of “1” is located and the voltage interval in which the memory cell with a threshold voltage of 0 is located. The second set of data may be data 11100000 read when the second reading is performed based on the read voltage V1, and two voltage intervals are obtained. According to the second set of data 11100000, two voltage intervals are obtained, which are the voltage interval in which the memory cell with a threshold voltage of “1” is located and the voltage interval in which the memory cell with a threshold voltage of 0 is located. The position flipped from 1 (0) to 0 (1) in the first set of data 11110000 and the second set of data 11100000 is determined as a voltage interval again, and a plurality of voltage intervals to which the threshold voltages of the memory cells in the first storage area belongs are obtained.

Of course, the first set of data may also be data read when the second reading is performed based on the reading voltage V1, and the second set of data may also be data read when the third reading is performed based on the reading voltage V2. For details, please refer to the examples shown in FIG. 18 and Table 5.

In some examples, the characteristic value of the first storage area is determined according to a plurality of voltage intervals of the threshold voltage in the first storage area.

In some examples, reference may be made to the examples shown in FIG. 21, FIG. 22, and FIG. 23.

In some examples, the log likelihood ratio of each voltage interval is obtained according to the decoded data and the plurality of voltage intervals to which the threshold voltages of the memory cells in the first storage area belong.

In some examples, reference may be made to the example shown in operation S240.

In some examples, a log likelihood ratio table is obtained according to the log likelihood ratio of each voltage interval of the threshold voltage in the first storage area and the characteristic value of the first storage area.

In some examples, reference may be made to the example shown in operation S240.

S450: Sending a plurality of second read instructions to the memory, where each of the second read instructions includes an address, a reference read voltage and a voltage offset of a second storage area of the memory, and where the voltage offsets in at least two of the plurality of second read instructions are different.

In some examples, the execution process of operation S450 is similar to that of operation S420, and specific reference may be made to the example shown in operation S420.

S460: Sending, by the memory, a plurality of sets of second data to the controller according to the plurality of second read instructions.

In some examples, the execution process of operation S460 is similar to that of operation S430, and specific reference may be made to the example shown in operation S430.

S470: Obtaining decoded data of the second storage area according to the plurality of sets of second data and the log likelihood ratio table.

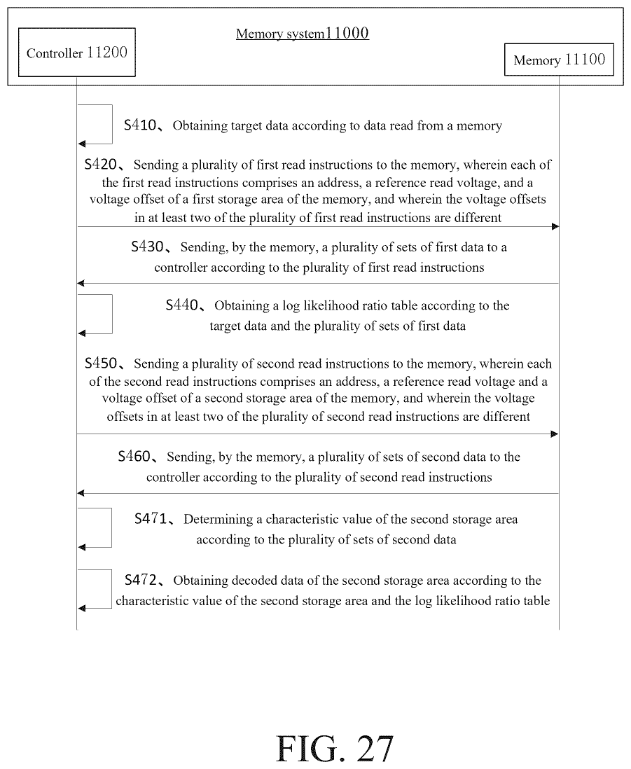

In some examples, as shown in FIG. 27, operation S470 includes operations S471-S472:

S471: Determining a characteristic value of the second storage area according to the plurality of sets of second data.

In some examples, the determination of the characteristic value of the second storage area may refer to the examples shown in FIG. 21, FIG. 22, and FIG. 23.

S472: Obtaining decoded data of the second storage area according to the characteristic value of the second storage area and the log likelihood ratio table.

In some examples, after optimizing the pre-defined LLR table in the LDPC soft decoding, when the controller 11200 decodes the data read out from the memory 11100, it first determines the characteristic value of the storage area where the read data is located, and then selects the corresponding LLR table in the optimized LLR table pool according to the characteristic value to decode the read data to obtain decoded data or target data.

This application provides a controller, a method of operating the controller, a memory system and electronic equipment. By considering the actual working status of the storage area in the memory 11100, precise optimization of the LLR table is achieved, so that the optimized LLR table is able to reflect the real characteristics of the storage medium more closely, thereby significantly improving the matching with the memory 11100. In addition, by introducing the LLR table classification method based on the characteristic values of the storage area, the controller 11200 can quickly and accurately match the most appropriate LLR table based on these characteristic values during the decoding process, which not only simplifies the matching process, but also greatly improves the efficiency of the LDPC soft decoding and improves the overall performance of the memory system 11000.

The present application also provides a computer-readable storage medium, which includes instructions. When the instructions are executed on the electronic device or memory system described in the above example, enable the electronic device or memory system to execute the method of operating the controller or memory system described in the above example.

The above includes only a specific example of the present disclosure, but the protection scope of the present disclosure is not limited thereto. Any changes or substitutions that can be easily thought of by a person skilled in the art within the technical scope disclosed by the present disclosure should be included in the protection scope of the present disclosure. Therefore, the protection scope of the present disclosure shall be based on the protection scope of the claims.

What is claimed is:

1. A controller, comprising:
a buffer; and
a processor coupled to the buffer and configured to:
send a plurality of first read instructions to a memory, wherein each of the first read instructions comprises an address, a reference read voltage, and a voltage offset of a first storage area of the memory, and wherein voltage offsets in at least two of the plurality of first read instructions are different;
obtain a plurality of sets of first data; and
obtain a log likelihood ratio table according to the plurality of sets of first data.

2. The controller of claim 1, wherein the processor is further configured to:
send a plurality of second read instructions to the memory, wherein each of the second read instructions comprises an address, a reference read voltage and a voltage offset of a second storage area of the memory, and wherein the voltage offsets in at least two of the plurality of second read instructions are different;
obtain a plurality of sets of second data; and
obtain decoded data of the second storage area according to the plurality of sets of second data and the log likelihood ratio table.

3. The controller of claim 1, wherein the processor is configured to:
determine a characteristic value of the first storage area according to the plurality of sets of first data; and
obtain the log likelihood ratio table according to the plurality of sets of first data and the characteristic value of the first storage area.

4. The controller of claim 3, wherein the processor is further configured to:
send a plurality of second read instructions to the memory to obtain a plurality of sets of second data, wherein each of the second read instructions comprises an address, a reference read voltage and a voltage offset of a second storage area of the memory, and wherein the voltage offsets in at least two of the plurality of second read instructions are different;
determine a characteristic value of the second storage area according to the plurality of sets of second data; and
obtain decoded data of the second storage area according to the characteristic value of the second storage area and the log likelihood ratio table.

5. The controller of claim 1, wherein the processor is further configured to:
obtain the log likelihood ratio table according to target data and the plurality of sets of first data, wherein the target data is obtained by the processor decoding data read from the first storage area.

6. The controller of claim 5, wherein the processor is configured to:
obtain a plurality of voltage intervals according to the reference read voltage and the voltage offset; and
obtain the log likelihood ratio table according to the target data and the plurality of voltage intervals.

7. The controller of claim 6, wherein the processor is configured to:
obtain a log likelihood ratio for each of the voltage intervals according to the target data and the plurality of voltage intervals; and
obtain the log likelihood ratio table according to the log likelihood ratio for each of the voltage intervals.

8. The controller of claim 5, wherein data stored in the first storage area has not been subjected to redundant array of independent disks (RAID) reconstruction.

9. The controller of claim 1, wherein each of the first read instructions comprises one reference read voltage and one voltage offset, and wherein the reference read voltage is offset based on the voltage offset.

10. The controller of claim 1, wherein each of the first read instructions comprises a first reference read voltage, a second reference read voltage, a first voltage offset and a second voltage offset, and wherein the first reference read voltage is offset based on the first voltage offset, and the second reference read voltage is offset based on the second voltage offset.

11. A method of operating a controller, comprising:
sending a plurality of first read instructions to a memory, wherein each of the first read instructions comprises an address, a reference read voltage, and a voltage offset of a first storage area of the memory, and wherein voltage offsets in at least two of the plurality of first read instructions are different;
obtaining a plurality of sets of first data; and
obtaining a log likelihood ratio table according to the plurality of sets of first data.

12. The method of claim 11, further comprising:
sending a plurality of second read instructions to the memory, wherein each of the second read instructions comprises an address, a reference read voltage and a voltage offset of a second storage area of the memory, and wherein the voltage offsets in at least two of the plurality of second read instructions are different;
obtaining a plurality of sets of second data; and
obtaining decoded data of the second storage area according to the plurality of sets of second data and the log likelihood ratio table.

13. The method of claim 11, further comprising:
determining a characteristic value of the first storage area according to the plurality of sets of first data; and
obtaining the log likelihood ratio table according to the plurality of sets of first data and the characteristic value of the first storage area.

14. The method of claim 13, further comprising:
sending a plurality of second read instructions to the memory to obtain a plurality of sets of second data, wherein each of the second read instructions comprises an address, a reference read voltage and a voltage offset of a second storage area of the memory, and wherein the voltage offsets in at least two of the plurality of second read instructions are different;
determining a characteristic value of the second storage area according to the plurality of sets of second data; and
obtaining decoded data of the second storage area according to the characteristic value of the second storage area and the log likelihood ratio table.

15. The method of claim 11, wherein obtaining a log likelihood ratio table according to the plurality of sets of first data comprises:
obtaining the log likelihood ratio table according to target data and the plurality of sets of first data, wherein the target data is obtained by a processor decoding data read from the first storage area.

16. The method of claim 15, wherein obtaining the log likelihood ratio table according to target data and the plurality of sets of first data comprises:
obtaining a plurality of voltage intervals according to the reference read voltage and the voltage offset; and
obtaining the log likelihood ratio table according to the target data and the plurality of voltage intervals.

17. The method of claim 16, wherein obtaining the log likelihood ratio table according to the target data and the plurality of voltage intervals comprises:
obtaining a log likelihood ratio for each of the voltage intervals according to the target data and the plurality of voltage intervals; and
obtaining the log likelihood ratio table according to the log likelihood ratio for each of the voltage intervals.

18. The method of claim 15, wherein data stored in the first storage area has not been subjected to redundant array of independent disks (RAID) reconstruction.

19. The method of claim 11, wherein each of the first read instructions comprises one reference read voltage and one voltage offset, and wherein the reference read voltage is offset based on the voltage offset.

20. A memory system, comprising:
a memory; and
a controller coupled to the memory and comprising:
a buffer; and
a processor coupled to the buffer and configured to:
send a plurality of first read instructions to the memory, wherein each of the first read instructions comprises an address, a reference read voltage, and a voltage offset of a first storage area of the memory, and wherein voltage offsets in at least two of the plurality of first read instructions are different;
obtain a plurality of sets of first data; and
obtain a log likelihood ratio table according to the plurality of sets of first data.
